(19) United States
(12) Patent Application Publication
(10) Pub. No.: US 2003/0229572 A1
(43) Pub. Date: Dec. 11, 2003

(54) Measurement and verification protocol for tradable residential emissions reductions

(75) Inventors: Franklin D. Raines, Washington, DC (US); Robert J. Sahadi, Clarksburg, MD (US); Kenneth Berlin, Bethesda, MD (US); Michelle Desiderio, Washington, DC (US); Scott Lesmes, Washington, DC (US); Craig D. Ebert, Arlington, VA (US); John D. Hall, Annapolis, MD (US); Marcia G. Trump, Fairfax, VA (US); Matt Howes, Fairfax, VA (US); Dean Gamble, Annandale, VA (US)

Correspondence Address: COLLIER SHANNON SCOTT, PLLC, 3050 K STREET, NW, SUITE 400, WASHINGTON, DC, 20007, US

(73) Assignees: ICF Consulting; Fannie Mae

(21) Appl. No.: 10/290,754

(22) Filed: Nov. 8, 2002

Related U.S. Application Data
(60) Provisional application No. 60/342,843, filed on Dec. 28, 2001.
(60) Provisional application No. 60/342,853, filed on Dec. 28, 2001.

(51) Int. Cl. G06F 17/60

(52) U.S. Cl. 705/37

(57) ABSTRACT

The present invention is directed to a system and method for quantifying residential emissions reductions. In particular, the system and method may comprise the steps of: measuring an energy savings resulting from an energy savings opportunity in a residential property, calculating an emissions reduction resulting from the energy savings, aggregating a plurality of emissions reductions into a tradable commodity, monitoring the residential energy savings opportunities, monitoring the quantification of the emissions reduction, and verifying the quantification of the emissions reduction. The system may include means for conducting each of these steps.

### CROSS REFERENCE TO RELATED APPLICATIONS

The present invention relates to, and is entitled to the benefit of the earlier filing date and priority of U.S. Provisional Application Serial No. 60/342,843, filed Dec. 28, 2001, which is hereby incorporated by reference. This application also relates to U.S. Provisional Application Serial No. 60/342,853, filed Dec. 28, 2001 and entitled “System and Method for Residential Emissions Trading.”

### FIELD OF THE INVENTION

The present invention relates to a system and method of quantifying tradable residential emission reductions.

### BACKGROUND OF THE INVENTION

Various systems and programs for quantifying and trading emissions credits have evolved in response to environmental legislations and/or regulations in the United States. For example, the “bubble concept” of treating an entire industrial complex as a single source, with a single allowable emission rate, was advanced by the U.S. steel industry in the late 1970s. This approach let companies choose the most cost-effective mix of controls to achieve the overall environmental goal for the facility. In contrast, the prevailing regulatory framework at that time imposed individual emission limits on each source within the complex. The U.S. Environmental Protection Agency (EPA) later adopted such a “bubble policy” for both air and water discharges.

In 1990, the Clean Air Act Amendments formally legislated emission trading. For the EPA Acid Rain Program, the Chicago Board of Trade has, since 1998, administered an annual auction of SO₂ (sulfur dioxide) allowances from private allowance holders (utilities or brokers) to regulated companies, brokers, environmental groups, and the general public. Beginning in 1999, the EPA Ozone Transport Commission NOₓ Budget Program has allowed trading in nitrogen oxides (NOₓ) credits in a group of U.S. states, to reduce summer smog.

The intra-plant bubble concept thereafter evolved to allow for trading of emission credits between companies. Pursuant to the 1997 Clean Air Act Amendments, EPA adopted regulations governing new source construction that permitted companies to offset emissions increases at one plant with savings at another, or to trade emissions credits between companies. This created a market for emissions credits. Brokerage companies typically handled sales between companies having emissions credits and those wanting to acquire credits.

Other domestic emission credit programs have been proposed or implemented on a state or regional level. The RECLAIM Program (Regional Clean Air Incentives Market) applies to stationary sources in southern California and is administered by the South Coast Air Quality Management District (SCAQMD). Trading of RECLAIM Trading Credits (RTCs) in sulfur oxides (SOₓ) and nitrogen oxides (NOₓ) began in 1994 in an effort to reduce the area's severe smog. If emissions are below the permitted limit, the excess RTCs may be sold to others or banked for future use.

The state of Maine proposed an Ozone Transportation Region in conjunction with the Maine Auto Emission Inspection Program, swapping NOₓ pollution credits from reduced auto emissions to allow increased industrial expansion. A Utah Division of Air Quality program provided for companies to earn emissions credits for SO₂ and carbon dioxide (CO₂) reductions. Massachusetts implemented a retail choice pilot program for residential and small business customers who purchased “green power” from solar and less-polluting power plants. Depending on the price that customers would pay for green power, the suppliers would retire a certain amount of SO₂ emissions credits.

The PERT Project (Pilot Emission Reduction Trading), in Ontario, Canada began in 1996 and comprises members from industry, government, and public interest organizations. Under PERT, Emission Reduction Credits (ERCs) are created when the pollution source reduces emissions below its actual level or regulated level. ERCs may be used by the source to meet current or future emissions caps, or may be sold. ERCs may be SO₂, NOₓ, CO₂, greenhouse gases (GHG) or other contaminants.

The measurement and verification (M&V) system of the present invention provides a novel system and method for promoting increased energy savings, which may be an actual reduction in electricity use (kWh), electric demand (kW), or thermal units (Btu), and reduced energy use at the level of the individual residential consumer. Increased residential energy efficiency may reduce energy consumption for electricity, natural gas, oil, and other energy sources. Less energy demand may result in reduced energy generation or on-site combustion by the utilities, and therefore in reduced emissions of a variety of pollutants including, but not limited to: nitrogen oxides (NOₓ), volatile organic compounds (VOCs), sulfur oxides (SOₓ), particulate matter (PM), carbon monoxide (CO), and greenhouse gases (GHG) such as carbon dioxide (CO₂) and methane (CH₄).

The SCQAMD's programs provide alternate methods of compliance with local emission reduction regulations. For example, in 1997, Rule 2506 established a voluntary program that encourages replacement of old, higher-emitting equipment (area sources) with lower-polluting technology. The Rule 2506 program generates low-cost emissions credits termed Area Source Credits (ASCs). Area sources include water heaters, home heaters, clothes dryers, and small boilers.

In one embodiment, the present invention also contemplates the replacement of such residential area sources, but in contrast to the Rule 2506 program, does not require the homeowner to submit a complicated plan for eligibility. The Rule 2506 plain requires, among other components, a Protocol for Emission Reduction Quantification, Documentation of the Occurrence and Extent of the Emission Reduction, Credit Calculation, and a Compliance Verification Report with annual certification signed under penalty of perjury. The present invention substantially reduces these transaction costs for the homeowner by taking care of such complexities at an administrative level.

The various schemes described above provide substantial incentives for certain industrial sources of pollution, such as utilities and industrial plants, to reduce their emissions. Notably lacking in these schemes, however, are programs for capturing the benefits of potential energy efficiency measures, which are activities designed to increase the energy efficiency of a facility, and the resulting emissions reductions by residential consumers.

Theoretically, residential emissions reductions could be recognized under a variety of emissions trading programs. However, five hurdles have historically kept reductions from residential housing sources off the market:

1. Residential emission savings are generated in very small quantities relative to those sought by the market;

2. Residential emission savings are not yet fully recognized by prior known regulatory regimes;

3. Residential emission savings are generated by many divergent homeowners with no means or incentive for collective action;

4. Transaction costs—those associated with certifying, marketing, selling, and transferring the reductions—have been prohibitive; and

5. Electricity producers have been reluctant to accept emission restrictions normally required prior to the regulator's granting of a utility displacement credit. A utility displacement credit is a type of emission credit that can be granted by the governing regulatory agency to entities that take actions that allow the utility to avoid delivery of power. Precedent is found under Clean Air Act programs. For example, a residence or industrial operation that generates its own power removes its demand from the grid. This reduction allows the utility to incrementally reduce its power generation which, in turn, results in an incremental emission reduction from power generating sources at the utility.

A residential emissions trading program that reduces or eliminates these hurdles is disclosed in Assignee's co-pending U.S. Provisional Patent Application No. 60/342,853, filed Dec. 28, 2001 and entitled “System and Method for Residential Emissions Trading,” which is incorporated herein by reference. This system and method may employ a M&V protocol of the present invention. M&V is the process of determining savings using a quantifying methodology. Alternatively, any other suitable quantification, measurement, and/or verification means may be employed. This program may aggregate emissions reductions through a number of mechanisms, such as direct purchase from homeowners, as a side transaction to mortgaging energy efficient homes, or by coordinating with other entities that are already in a role of aggregating customers (i.e., multi-family building owners, energy service companies, and utility companies). Emissions reductions from individual homes are insignificant when measured alone but, when aggregated, can have substantial environmental and financial value. Aggregating can provide individual homeowners with a mechanism to add value to individual actions through collective action. Aggregating the emission reductions can also reduce the per pound transaction cost of an emissions reduction program and improve the potential to secure recognition for utility reduction credits and residential emissions savings.

Residential housing units account for approximately one-fifth of greenhouse gas (GHG) emissions in the U.S. Building more efficient homes, retrofitting existing ones, making other structural and fuel changes, and/or other improvements, can dramatically decrease the amount of energy used. Energy efficiency improvements are made to residential units in some instances in response to energy company demand-side management programs, consumer upgrades, and/or builder incentives.

Yet, the energy savings from a single individual home has an insignificant impact at electricity generation plants. The aggregate impact of energy efficiency upgrades to thousands of homes, however, could have a significant impact, such as measurable reductions in peak load.

Decreases in energy consumption naturally lead to reductions in pollutant emissions (i.e., criteria pollutants and greenhouse gases). Other measures, such as switching to low-VOC paints, paving driveways, and improving home design, can also have significant impacts on air pollution. Although the air quality impact of a single energy efficient home is relatively small, the result can be dramatic when the emissions reductions from large numbers of homes are aggregated. When the individual residential energy savings are aggregated in sufficient volumes, the program of “System and Method for Residential Emissions Trading” contemplates that the aggregation may comprise a tradable commodity in existing and future emissions trading markets.

Embodiments of the present invention provide credible monitoring and verification procedures for various potential energy efficiency programs in order to:

Define a common M&V language to be used by participants in a residential emissions trading program;

Define an acceptable methodology for deriving emissions reductions from energy savings;

Define acceptable methods for quantifying energy savings and emissions reductions;

Evaluate the technical rigor of existing M&V techniques for energy savings and emissions reductions and determine technical confidence factors (“TCF”) for calculating tradable emissions reductions; and

Explain the relationship between technical rigor and economic feasibility of existing and planned M&V protocols.

In one embodiment of the present invention, the residential energy savings may be captured in the emissions reductions realized by utility companies that generate less power. In another embodiment, upgrades in residential appliances—for example, changing a fuel oil-powered device to a solar-powered device—may produce direct emissions reductions. The residential reductions in SOₓ, NOₓ, CO₂, VOC, etc., emissions may be captured in tradable credits. In a third embodiment, emissions reductions may be generated both by the residential upgrade and the utility's generation of less power.

In a program for residential emissions trading, utilities, builders, and homeowners may cooperate to encourage the improvements in the energy efficiency of residential properties, in exchange for the SOₓ, NOₓ or other pollutant reductions that the efficiencies generate. Alternatively, an emissions trading initiative (ETI) may support a GHG emissions trading market for emissions reductions from efficient energy use and fuel switching in residential buildings. The resulting residential emissions reductions may be bundled into an emissions pool and sold into an emissions trading market.

As part of a program for residential emissions trading, an M&V protocol ensures that the energy reductions from an energy efficiency measure are quantified as accurately as practicable. Quantification protocols ensure that the emission reductions are reliably ascertained. A rigorous M&V program provides assurance to potential parties in the emission trading market that reductions—and most important credits—are both actual and quantifiable. M&V protocols, therefore, have become an important part of many emissions trading markets.

For each energy savings opportunity or energy efficiency program, the energy consumption with the energy efficiency program may be subtracted from the energy consumption without the energy efficiency program, giving the energy savings from the program. Energy consumption is calculated from a number of measurable variables and their associated measurement techniques.

In an embodiment, the present invention contemplates quantifying the following aspects of a given energy efficiency (or emissions reduction) project:

1. Annual energy use in the baseline home (without upgrades) for each year in the life of the project;

2. Annual energy use in the upgraded home (with installed energy efficiency measures) for each year in the life of the project;

3. Appropriate emission factors for the energy consumed for each year in the life of the project;

4. Total emissions reductions from the project; and

5. Tradable portion of these emission reductions.

For each type of energy efficiency project, specific data types and analytical procedures may be identified. Entities cooperating in the emissions trading program may be responsible for data collection (i.e., measurement) for their energy efficiency programs. Using an M&V procedure of the present invention, the data are compiled and used to assess the emissions reductions potential for each residential energy efficiency opportunity.

The present invention has many potential benefits. Energy costs are typically the second largest cost for homeowners. The present invention, when implemented in an emissions trading program such as that disclosed in Assignee's co-pending application for a “System and Method for Residential Emissions Trading,” provides incentives to invest in energy efficiency that will save the homeowner money. It has been estimated, for example, that an efficient house can save 30% on annual energy bills. In addition, the present invention improves the stability of the emissions credits—a valuable new commodity—and also helps to decrease the costs associated with energy efficiency.

It is therefore an advantage of some, but not necessarily all, embodiments of the present invention to provide a system and method for residential emissions trading.

It is another advantage of some, but not necessarily all, embodiments of the present invention to provide a system and method for determining an emissions reduction resulting from a residential energy savings.

It is yet another advantage of some, but not necessarily all, embodiments of the present invention to provide an M&V protocol that ensures that emissions reductions are reliably ascertained.

Additional advantages of various embodiments of the invention are set forth, in part, in the description that follows and, in part, will be apparent to one of ordinary skill in the art from the description and/or from the practice of the invention.

### SUMMARY OF THE INVENTION

In response to the foregoing challenges, an innovative method for quantifying residential emissions reductions is provided, comprising the steps of: measuring an energy savings resulting from one or more energy savings opportunities in one or more residential properties; calculating an emissions reduction resulting from the energy savings; and aggregating a plurality of the emissions reductions into a tradable commodity.

The step of calculating an emissions reduction may further comprise calculating a reduction in emissions of one or more compounds. The one or more compounds may be selected from the group consisting of: SO₂, NOx, and GHGs. The method may further comprise the step of monitoring the residential energy savings opportunities. The method may further comprise the step of monitoring the quantification of the emissions reduction. The method may further comprise the step of verifying the quantification of the emissions reduction.

According to another embodiment of the present invention, the method for quantifying residential emissions reductions comprises the steps of: estimating an energy savings resulting from one or more energy savings opportunities in one or more residential properties; calculating an emissions reduction resulting from the energy savings; aggregating a plurality of the emissions reductions into a tradable commodity; monitoring the residential energy savings opportunity; monitoring the quantification of the emissions reduction; and verifying the quantification of the emissions reduction.

The step of estimating an energy savings may further comprise the step of estimating energy saved by one or more energy efficiency upgrades selected from the group consisting of: replacement of an appliance; upgrade of a domestic water heating system; upgrade of a heating system; upgrade of an air conditioning system; modification to lighting; fuel switching; and whole home renovation. The step of aggregating a plurality of the emissions reductions may further comprise the step of aggregating the emissions reductions produced by the one or more energy efficiency upgrades into a tradable commodity.

The step of aggregating the emissions reductions may further comprise the step of pooling the emissions reductions, or alternatively, converting the emissions reductions into one or more emissions trading credits.

The step of calculating an emissions reduction resulting from the energy savings may further comprise the step of calculating a forecasted emissions reduction. The step of calculating a forecasted emissions reduction may further comprise the steps of: estimating a forecasted baseline energy use for the energy savings opportunity; estimating a forecasted baseline emissions factor for the energy savings opportunity; calculating a forecasted baseline emissions by multiplying the forecasted baseline energy use with the forecasted baseline emissions factor; estimating a forecasted program energy use for the energy savings opportunity; estimating a forecasted program emissions factor for the energy savings opportunity; calculating a forecasted program emissions by multiplying the forecasted program energy use with the forecasted program emissions factor; and calculating a forecasted emissions reduction by subtracting the forecasted program emissions from the forecasted baseline emissions.

The method may further comprise the step of calculating a tradable portion of the forecasted emissions reduction. The step of calculating a tradable portion of the forecasted emissions reduction may further comprise the step of quantifying a TCF for the energy savings opportunity. The step of quantifying a TCF may further comprise the steps of: identifying a risk factor for energy savings estimates; identifying a risk factor for emissions factor estimates; identifying an adjustment factor; and determining the TCF by its relationship to the sum of the risk factor for energy savings estimates, the risk factor for emissions factor estimates, and the adjustment factor.

The method may further comprising the steps of: multiplying the TCF with the emissions reduction to obtain the tradable portion of the emissions reduction, wherein the remaining portion of the emissions reduction is non-tradable; and holding the non-tradable portion in reserve for possible conversion into a tradable commodity. The method may also comprise the step of converting any portion of the non-tradable portion into a tradable commodity.

The step of calculating a forecasted emissions reduction may further comprise the steps of: calculating a plurality of annual forecasted emissions reductions for the residential energy savings opportunities; and summing the plurality of annual forecasted emissions reductions to determine a lifetime emissions reduction estimate for the residential savings opportunities.

The step of monitoring the residential savings opportunity may further comprise the steps of: compiling data on the energy savings collected at a facility; and managing the energy savings data.

The step of verifying the quantification of the emissions reduction may further comprise the steps of: calculating a measured emissions reduction; and comparing the measured emissions reduction to a forecasted emissions reduction. The step of calculating a measured emissions reduction may further comprise the step of collecting data for the energy savings opportunity. The step of calculating a measured emissions reduction may further comprise the steps of: estimating a measured baseline energy use for the energy savings opportunity; estimating a measured baseline emissions factor for the energy savings opportunity; calculating a measured baseline emissions by multiplying the measured baseline energy use with the measured baseline emissions factor; estimating a measured program energy use for the energy savings opportunity; estimating a measured program emissions factor for the energy savings opportunity; calculating a measured program emissions by multiplying the measured program energy use with the measured program emissions factor; and calculating a measured emissions reduction by subtracting the measured program emissions from the measured baseline emissions.

The steps of estimating a measured baseline energy use and estimating a measured program energy use may be selected from one or more of the group consisting of conducting: on-site inspection; metering; sub-metering; utility bill analysis; and engineering modeling. The step of conducting engineering modeling may further comprise the step of utilizing one or more of: engineering calculations and computer simulation. The step of conducting engineering modeling may further comprise the step of conducting one or more of: degree day analysis; bin analysis; hourly analysis; and time-step analysis.

In accordance with another embodiment of the present invention, the method for quantifying a tradable emissions commodity comprises the steps of: offering a plurality of residential energy efficiency programs, wherein the energy efficiency programs comprise a plurality of residential energy savings opportunities; estimating an energy savings resulting from the plurality of residential energy savings opportunities; calculating emissions reductions resulting from the energy savings; aggregating the emissions reductions into a tradable commodity; monitoring the residential energy savings opportunities; monitoring the quantification of the emissions reductions; and verifying the quantification of the tradable emissions reductions to produce a tradable commodity.

The plurality of residential energy efficiency programs may be offered by one or more emissions trading partners. The step of verifying the quantification of the tradable emissions reductions may further comprise the step of producing a commodity that is tradable on national and international emissions trading markets. The method may further comprise the step of offering to a market one or more of the tradable commodities. The step of offering to a market one or more of the tradable commodities may further comprise the step of managing one or more transactions of the tradable commodities in the market.

It is to be understood that both the foregoing general description and the following detailed description are exemplary and explanatory only and are not restrictive of the invention as claimed. The accompanying drawings, which are incorporated herein by reference and which constitute a part of the specification, illustrate certain embodiments of the invention and, together with the detailed description, serve to explain the principles of the present invention.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is a flow chart depicting a method of quantifying reductions in residential pollution emissions according to an embodiment of the present invention.

FIG. 2 is a flow chart depicting a method of estimating an energy savings, calculating an emissions reduction, aggregating emissions reductions, monitoring the residential energy savings opportunities, and monitoring and verifying the quantification of the emissions reductions according to an another embodiment of the present invention.

FIG. 3 is a flow chart depicting the steps of measuring an energy savings according to an embodiment of the present invention.

FIG. 4 is a flow chart depicting the steps of calculating an emissions reduction from an energy savings according to an embodiment of the present invention.

FIG. 5 is a graph depicting greenhouse gas add-on sampling versus creditable emissions according to prior art M&V programs.

FIG. 6 is a graph depicting baseline and program emissions with emission reductions according to an embodiment of the present invention.

FIG. 7 is a flow chart depicting forecasted baseline and program emissions according to an embodiment of the present invention.

FIG. 8 is a flow chart depicting measured baseline and program emissions according to an embodiment of the present invention.

FIG. 9 is a graph depicting calculated forecast emission reductions and tradable emissions reductions versus year of program for an embodiment of the present invention.

FIG. 10 is a graph depicting calculated forecast and measured emission reductions and tradable emissions reductions versus year of program for an embodiment of the present invention.

FIG. 11 is a graph depicting calculated forecast emission reductions, measured emission reductions, and tradable emissions reductions versus year of program for another embodiment of the present invention.

FIG. 12 is a graph depicting the correlation between heating degree days and heating energy consumption according to another embodiment of the present invention.

### DETAILED DESCRIPTION OF EMBODIMENTS OF THE INVENTION

Reference will now be made in detail to embodiments of the system and method of the present invention, examples of which are illustrated in the accompanying drawings.

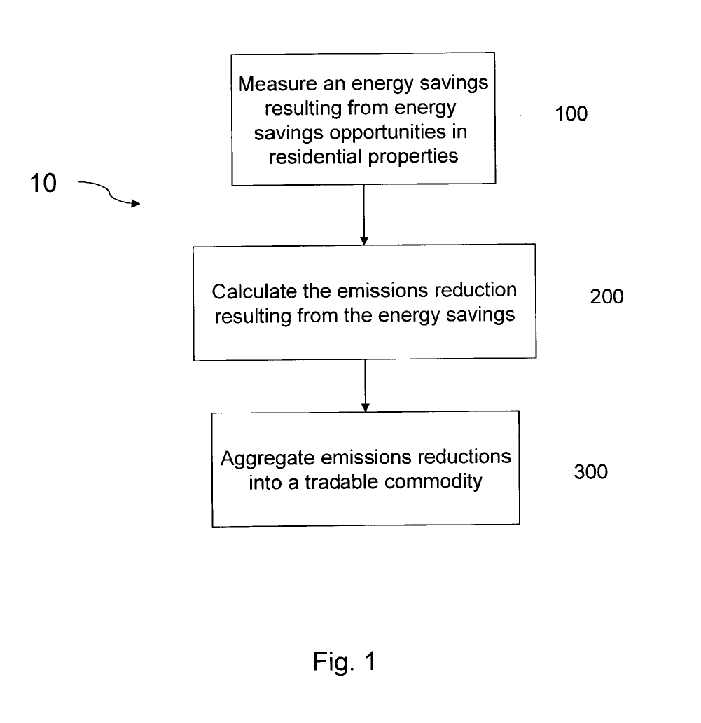

With reference to FIG. 1, the method 10 for quantifying reductions in residential emissions may comprise the steps of measuring an energy savings resulting from one or more energy savings opportunities in one or more residential properties 100, calculating an emissions reduction resulting from the energy savings 200, and aggregating a plurality of the emissions reductions into a tradable commodity 300. The tradable commodity may comprise tradable emissions reduction(s), tradable emissions credit(s), or any other suitable commodity for trading in any emissions trading market.

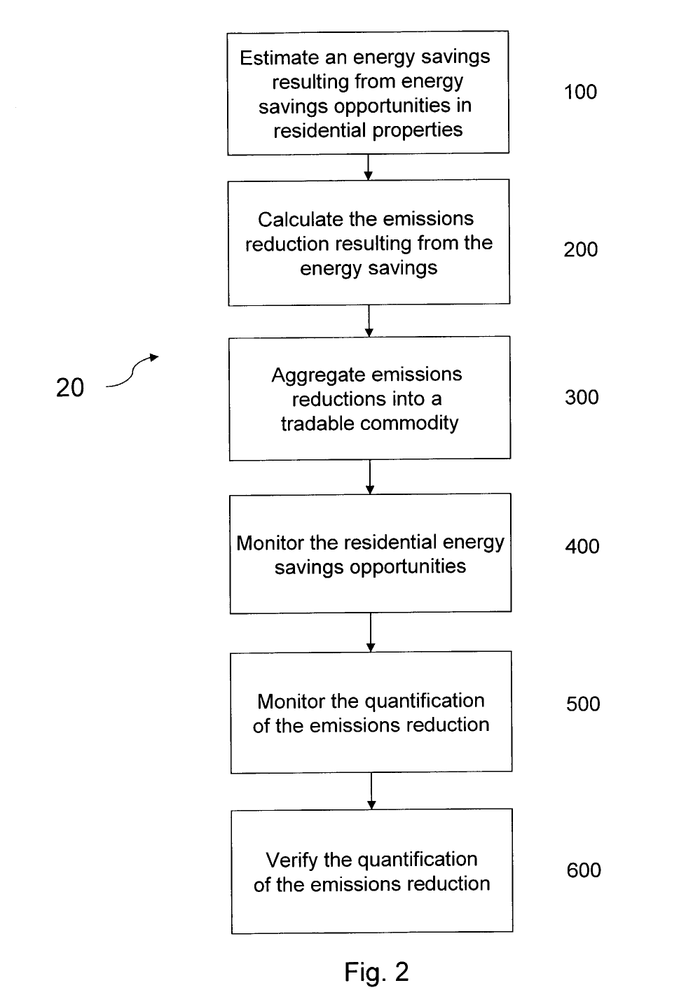

According to another embodiment depicted in FIG. 2, the method 20 may comprise the steps of estimating an energy savings resulting from one or more energy savings opportunities in one or more residential properties 100, calculating an emissions reduction resulting from the energy savings 200, aggregating a plurality of the emissions reductions into a tradable commodity 300, monitoring the residential energy savings opportunities 400, monitoring the quantification of the emissions reduction 500, and verifying the quantification of the emissions reduction 600.

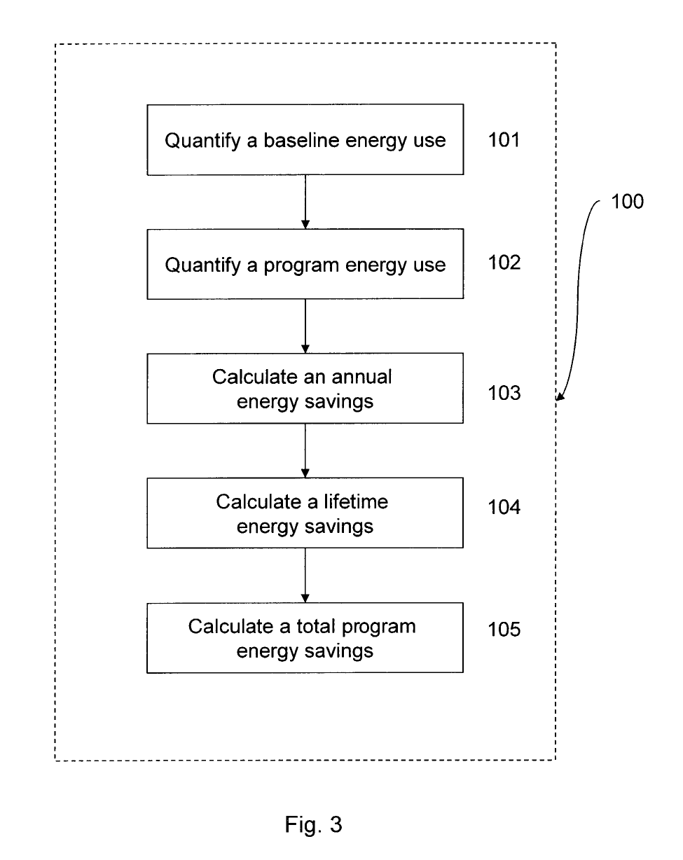

As embodied herein and as shown in FIG. 3, the step of measuring an energy savings resulting from one or more energy savings opportunities in one or more residential properties 100 may comprise the steps of quantifying a baseline energy use 101, quantifying a program energy use 102, calculating an annual energy savings 103, calculating a lifetime energy savings 104, and calculating a total program energy savings 105. The equations are shown below (Equations 1a -1f).

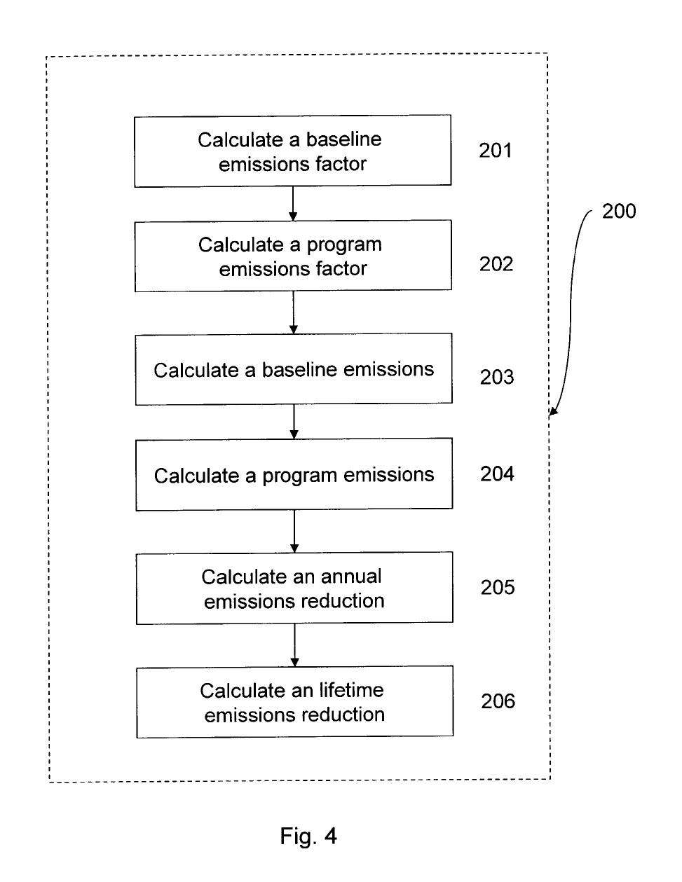

Calculating the emissions reduction may comprise calculating a reduction in emissions of one or more compounds, e.g., pollutants. Such compounds may include, but are not limited to, SO₂, NOₓ, GHGs, and any other suitable compounds that may be converted into a tradable commodity in any emissions trading market. As embodied herein and as shown in FIG. 4, the step of calculating the emissions reduction 200 may further comprise the steps of calculating a baseline emissions factor 201, calculating a program emissions factor 202, calculating a baseline emissions 203, calculating a program emissions 204, calculating an annual emissions reduction 205, and calculating a lifetime emissions reduction 206. The equations are shown below (Equations 1g-1l).

Embodiments of the present invention may also comprise an M&V protocol for participants in a residential emissions trading program, including but not limited to: program partners; program administration staff; third party auditors; and program investors.

In an embodiment of the present invention, the M&V protocol may focus on the specification of measurement protocols that may be implemented by the program partners. It also, however, may include monitoring protocols that may be implemented by program administration staff, and verification protocols that may be implemented by third party auditors. Monitoring may comprise the collection of data at a facility over time, such as, for example, energy and water consumption, temperature, humidity, and hours of operation. A purpose of the monitoring protocol may be to compile and manage the data collected by the program partners. Verification may comprise the process of examining reports of others to comment on their suitability for the intended purpose. The verification protocol may act as a quality assurance mechanism on the data submitted by the utility partners (for the benefit of the program investors).

A primary responsibility of program partners may be to carry out the measurement of emissions reductions from qualifying energy efficiency programs or improvements. A primary responsibility of program administration staff may be data collection and management. A primary responsibility of third party auditors may be quality assurance and quality control (on data supplied by program partners) for program investors. A primary responsibility of program investors may be to provide the primary source of funding for the emission trading program.

As embodied herein, the M&V protocol may be modified for several types of projects aimed at improving energy efficiency in residential buildings. An embodiment of the present invention may comprise a sequence of steps that typically are followed in establishing estimated savings and emissions reductions and verifying the actual savings and emissions reductions from any given energy efficiency program:

1. Measurement of the energy savings;

2. Quantification of the emissions reductions and assignment of tradable emission reductions;

3. Monitoring of data collection for the energy savings;

4. Monitoring of the quantification of the emissions reductions; and

5. Verification of the quantification of the emissions reductions.

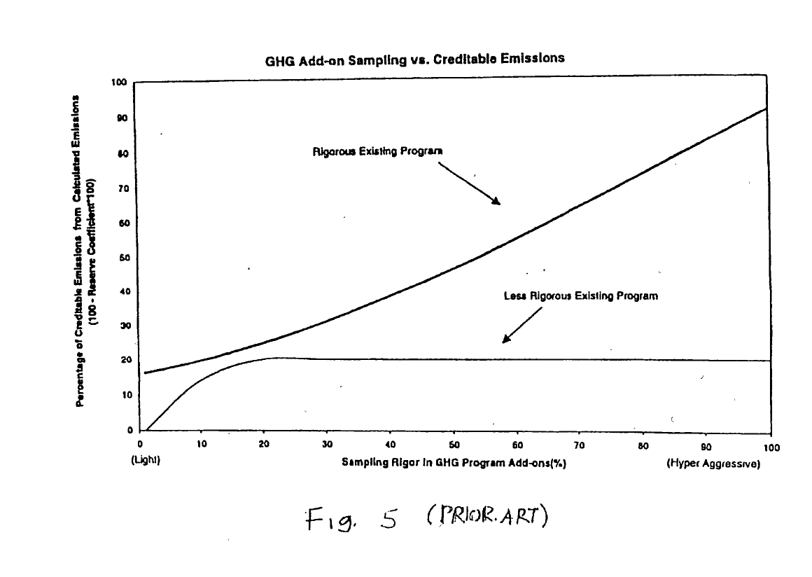

An embodiment of the present invention may be designed to address the needs of different participants in a residential emissions trading program. It is anticipated that as demand for tradable emissions increases in the marketplace (and the value of tradable emissions increases), that a more rigid (or less flexible) approach to M&V may be warranted. As shown in FIG. 5, the sampling rigor in existing programs has a direct correlation to the amount of creditable emissions that are generated (in this example, for a greenhouse gas program).

An emissions trading initiative of embodiments of the present invention is intended to create a marketplace for the trading of emission reductions that result from energy efficiency programs. Energy efficiency programs may reduce household energy consumption through the implementation of more efficient technologies or the maintenance of existing devices within the home.

To calculate the emission reductions from an energy efficiency program, the baseline energy use and the resulting emissions may be calculated. Baseline emissions are those emissions that would have occurred if the energy efficiency project had not been undertaken, or if the status quo had not been altered by the energy efficiency project. This baseline may not be constant over time, because changes in occupant behavior, weather, and/or other factors may affect the baseline energy use and emissions.

Once the baseline emissions have been calculated, program emissions may be calculated. Program emissions are those emissions that occur after the energy efficiency project has been installed or completed. Program emissions may also change in time, due to the effects of occupant behavior, weather, and/or other factors.

After the baseline emissions and the program emissions have been calculated, the emissions reductions may be calculated as the difference between the baseline and the program emissions. The emissions reduction, shown in FIG. 6, is the amount of emissions that are avoided due to the energy efficiency project.

### Measurement of Residential Energy Savings

Step 100, measuring an energy savings resulting from one or more energy savings opportunities in one or more residential properties, may comprise any one or more of a variety of improvements. Examples of energy efficient upgrades include, but are not limited to: replacing older appliances with more energy efficient appliances; upgrading domestic hot water (DHW) heating systems, electric or gas; upgrading heating, ventilation, and/or air conditioning (HVAC) systems; modifying lighting; fuel switching; renovating the entire home; and myriad other home improvements. Purchase of new homes with more energy efficient systems or upgrades from existing systems to more energy efficient ones are both contemplated by the present invention.

### Data Collection

As embodied herein, measuring an energy savings 100 may comprise measuring and collecting data for the particular type of energy efficiency program or energy savings opportunities. Means for measuring an energy savings are described below in “Measurement Techniques.” For each type of program, a number of different data collection methods may be used. The collected data may be used to calculate the energy savings and the corresponding emissions reductions and, ultimately, the tradable emissions reductions.

Before undertaking a data collection effort, it may be advantageous to identify the type of calculations that will be used. Different methods of data collection may comprise different inputs. In some cases, a slight increase in data collection effort (whether surveying, sub-metering, utility bill collections, or other means) may result in a substantial increase in the portion of emissions reductions that are tradable.

On-site inspection, metering, sub-metering, utility bill analysis, engineering modeling, or any combination thereof may be used to assess the energy savings. On-site inspections may be random, and may comprise report review, visual inspection, and device rating verification. Metering may comprise collecting energy and water consumption data over time at a facility through the use of measurement devices. Utility bill analysis may comprise analyzing: samples of measured data of the energy savings from the residential properties; samples of control data of residential energy use; raw data; data normalized by weather; stratified data; data that are both stratified and weather-normalized; or a combination thereof.

Additional measuring methodologies may include engineering calculations or computer simulation to assess an energy savings. Computer simulation may utilize computer-based building energy software. Engineering modeling may use heating degree day analysis, bin analysis, hourly analysis, time-step analysis, or any combination thereof.

### Energy Savings

For a given energy savings opportunity or energy efficiency improvement program, energy savings may be calculated in step 100, as shown in FIG. 3, as the difference between baseline energy use and post-implementation or program energy use. Baseline energy use may be calculated as the product of instantaneous demand for energy multiplied by the hours of operation of the relevant energy consuming equipment without the implementation of any energy efficiency improvements (see Equation 1a). Calculations may be for a baseline year, which is a defined period of any length before implementation of an energy conservation measure. Program energy use (after completion of the installation of the energy efficiency improvements) may be calculated in a similar manner (see Equation 1b). The annual energy savings may then be calculated as the difference between the baseline energy use and the program energy use (see Equation 1c).

$$Baseline Energy Use = {\sum }_{i = 1}^{h} {KW}_{i} \qquad ( Eq . 1 a )$$

Where:

KWᵢ=Instantaneous demand for energy at hour “i”, without implementation of energy efficiency measures, expressed in kW (kilowatts).

h=Annual number of hours of operation of energy consuming equipment without implementation of energy efficiency measures (hours per year)

$$Program Energy Use = {\sum }_{i = 1}^{h} {KW}_{ip} \qquad ( Eq . 1 b )$$

Where:

KWᵢₚ=Instantaneous demand for energy in the hour “i”, at completion of the energy efficiency program, expressed in kW (kilowatts).

h=Annual number of hours of operation of energy consuming equipment at completion of the energy efficiency program (hours per year).

$$Annual Energy Savings = Baseline Energy Use - Program Energy Use \qquad ( Eq . 1 c )$$

The baseline energy use may be expressed as a series of annual energy use estimates, one for each year in the anticipated life of the energy efficiency program. For example, if an energy efficiency program is expected to have a ten-year lifetime, then the baseline energy use can be a series of ten energy use estimates. Each value in the series represents the expected annual energy use (without any energy efficiency improvements) for a given year. Similarly, the program energy use and the annual energy savings may also be expressed as a time series of values, one for each year in the life of the program.

$$Lifetime Energy Saving = {\sum }_{j = 1}^{y} ( {BaselineEnergyUse}_{j} - {ProgramEnergyUse}_{j} ) \qquad ( Eq . 1 d )$$

Where:

Baseline Energy Useⱼ=Energy use without the implementation of energy efficiency measures, in the year “j.”

Program Energy Useⱼ=Energy use with implementation of energy efficient measures (i.e., program), in the year “j.”

y=Number of years in the life of the program.

Prior to program implementation, an initial estimate (for each year of the program life) may be made for the baseline energy use, the program energy use, and the annual energy savings. These initial estimates may be based on engineering calculations, or any other suitable methodology. After the energy efficiency program is implemented, these initial estimates may be updated with monitored data from the field programs.

The total net energy savings from an energy efficiency program may be determined by summing the total of energy savings (from Equation 1d) across all involved households:

$$Total Program Energy Savings = \sum {ES}_{h} \qquad ( Eq . 1 e )$$

Where:

ES=Lifetime Energy Savings from Eq. 1d.

ₕ=Subscript denoting the number of Households.

In cases where types of households differ, they may be grouped according to similar characteristics, and summed by group as follows:

$$Total Program Energy Savings = \sum ( {HH}_{g} * {AES}_{g} ) \qquad ( Eq . 1 f )$$

Where:

_{g}=Subscript denoting a group of households with similar characteristics.

HH=Number of households in a particular group.

AES=Average energy savings of a home in group _{g.}

### Emission Factors

Emission factors may be employed in step 200 to correlate reductions in energy consumption with their associated emission reductions. Emission factors may indicate the amount of emissions generated per unit of energy. They are essentially conversion factors, translating energy measurements (kWh or other appropriate units) to quantifiable emissions reductions in tonnes per carbon equivalent (TCE) or other pollution emission.

The residential energy efficiency programs or energy savings opportunities discussed below may convert fuels into productive energy and polluting emissions. The amount of emissions and energy generated may be dependent on the characteristics of the device (device type, efficiency, pollution reduction, etc.) and on the type of fuel (or source of electricity). Through quantifying the efficiency levels and other key variables specific to the appliances, systems, and devices under consideration in the present invention, it may be possible to calculate the emissions that result from their use and develop a simple factor to use for this conversion.

EPA has compiled a substantial body of information on emissions factors in the “Compilation of Air Pollutant Emission Factors” (also known as AP42), which is incorporated herein by reference. This compilation can be found on the EPA website at http://www.epa.gov/ttn/chief/index.html. The data is summarized in EPA's E-Grid database, which contains emissions factors at the national, state, and utility level. Examples of some of the EPA factors include:

Natural Gas, Fuel Oil, and Coal, which are consumed off-site. Therefore the emission factors are dependent on the characteristics of the device that is consuming the fuel and the fuel used. For example, there are several different kinds of fuel oil. The sulfur content of coal varies geographically. When these variables have been compiled, the appropriate emission factors are available from published references.

Electricity emission factors are not calculated with site-based information. The emissions from electricity generation occur at the power plants that produce the electricity. Emission factors, therefore, are based on power plants' emission factors. In many cases the electricity comes from the grid and consequently the emission factor is a function of the individual emission factors from multiple power plants.

In steps 201 and 202 of FIG. 4, the following equations may be used to calculate emission factors.

$$Baseline Emission Factors = Average ( {EF}_{i} {=}_{1 … h} ) \qquad ( Eq . 1 g )$$

Where:

EFᵢ=Marginal Emission Factor for the baseline, in a given hour of the year “i”.

ₕ=Subscript denoting the number of hours of equipment operation in the year.

$$Program Emission Factors = Average ( {EF}_{i} {=}_{1 h} ) \qquad ( Eq . 1 h )$$

Where:

EFᵢ=Marginal Emission Factor for the program, in a given hour of the year “i”.

ₕ=Subscript denoting the number of hours of equipment operation in the year.

In accordance with an embodiment of the present invention, current or updated EPA emission factors may be utilized for determining emissions reductions, or program participants may provide their own emission factors.

### Emissions

In step 203, baseline emissions may be calculated as the product of baseline energy consumption and emissions factors for the appropriate fuel source (see Equation 1i). Similarly, in step 204 program emissions may be calculated as the product of the program energy consumption and emissions factors for the appropriate fuel source (see Equation 1j).

$$Baseline Emissions = {\sum }_{i = 1}^{h} Baseline Energy {Use}_{i} * {EF}_{i} \qquad ( Eq . 1 i )$$

Where:

EFᵢ=Emission Factor for the baseline, in a given hour of the year “i”.

h=Number of hours of equipment operation in the year.

$$Program Emissions = {\sum }_{i = 1}^{h} Program Energy {Use}_{i} * {EF}_{i} \qquad ( Eq . 1 j )$$

Where:

EFᵢ=Emission Factor for the program, in a given hour of the year “i”.

h=Number of hours of equipment operation in the year

### Emissions Reductions

In step 200, emissions reductions may be calculated as the difference between baseline pollutant emissions (for a given pollutant) and program (post-implementation) pollutant emissions. Annual emissions reductions may be calculated in step 205 (see Equation 1k).

$$Annual Emissions Reductions = Baseline Emissions - Program Emissions \qquad ( Eq . 1 k )$$

Baseline emissions may also be expressed as a series of annual emissions estimates—one for each year in the anticipated life of the energy efficiency program (as described above for annual energy savings). Each value in the series represents the expected annual emissions (without any energy efficiency improvements) for a given year. Similarly, program emissions and annual emissions reductions may be expressed as a time series of values—one for each year (or other appropriate time period) in the life of the project. These annual values may be summed, as shown in the following equation, to calculate lifetime emissions reductions in step 206.

$$Lifetime Emissions Reductions = {\sum }_{j = 1}^{y} ( Baseline {Emissions}_{j} - Program {Emissions}_{j} ) \qquad ( Eq . 1 l )$$

Where:

Baseline Emissionsⱼ=Baseline emissions in the year “j”.

Project Emissionsⱼ=Program emissions in the year “j”.

y=Number of years in program life.

Quantifying emissions reductions from measures taken to increase energy efficiency may require data on—and is the product of—energy savings and emission factors specific to each measure, opportunity, or program. These estimates may comprise an equation, two variations of which are shown in Equations 1i and 1j. Both equations, as well as those presented in the following sections, are essentially the same for both future baseline forecasts and program estimates. The significance of the changes in the variables may be dependent upon the specific action taken to increase energy efficiency.

As embodied herein, the methodology for quantifying energy consumption and savings for the energy savings opportunities or energy efficiency programs may be similar to that for calculating baseline data above. Procedures for calculating various areas of potential energy efficiency upgrades are described in the following sections, including, but not limited to, energy efficient appliance, domestic water heating, HVAC, lighting, fuel switching, and whole house programs. Other suitable energy efficiency upgrades are considered well within the scope of the present invention.

As described above under “Data Collection,” there are a number of methods in which to estimate and/or measure energy savings from each of these program types, including: on-site inspections; engineering calculations; billing analysis; metering; sub-metering; and any other appropriate means.

The quality of the overall energy savings assessment may be dependent on the estimation or (measurement) approach used. A TCF may assign varying degrees of confidence to an energy savings estimate. Quantification of TCFs is described below under “Calculation of Technical Confidence Factors.”

### Energy Efficient Appliance Programs

Average household energy efficiency may be increased by replacing less efficient appliances with more efficient alternatives. Newer and more energy efficient appliances generally consume less energy, without sacrificing performance. Energy efficient products may also provide energy-saving benefits by working faster, thereby using energy for less time. Appliance upgrades may include: refrigerators; stoves and ovens; clothes washers and dryers; dishwashers; and any other appropriate appliances.

### Energy Savings Equations for Appliance Programs

The energy savings from an appliance upgrade may be calculated as follows:

$$\begin{matrix}Energy Consumption ( EC ) = \sum [ ( {kW}_{i} * {D}_{i} ) / OBI ] & ( Eq . 2 a ) \\ Net Energy Savings = ( {EC}_{b} - {EC}_{pi} ) * {OBI}_{pi} & ( Eq . 2 b )\end{matrix}$$

Where:

D=Duration over which energy consumption is estimated (hours).

kW=Power demand of the appliance (in kilowatts).

ᵢ=Subscript denoting the interval during which power demand remains constant.

_{b}=Subscript denoting the baseline scenario.

ₚᵢ=Subscript denoting the post-implementation scenario.

OBI=Occupant behavior index.

Equation 2a determines the area under a graph of kilowatt-hours as the dependent variable against time. Energy consumption may be calculable both pre- and post-implementation, and may be useful in quantifying consumption for a baseline scenario, as well as under an energy efficiency program scenario. Because appliances generally operate at different power demands over time, the product of power demand and the duration of time at that power demand may be summed in order to arrive at the total energy consumption for a particular appliance. The occupant behavior index (OBI) may be useful when additional information is available concerning occupant behavior over time (due to shifting prices or relocation). OBI is an indicator variable for the occupant behavior, which may range from 0 to 1. OBI may be used to normalize energy consumption based on variations in occupants' behavior or presence, and where occupant behavior directly impacts energy consumption.

The total net energy savings from an energy efficiency program may comprise the total of energy savings (from Equation 2b) summed across all households participating in the program.

$$Total Program Energy Savings = \sum {ES}_{h} \qquad ( Eq . 2 c )$$

Where:

ES=Energy Savings.

ₕ=Subscript denoting the number of households participating in the program.

In cases where types of households differ, they may be grouped according to similar characteristics, and summed by group as follows:

$$Total Program Energy Savings = \sum ( {HH}_{g} * {AES}_{g} ) \qquad ( Eq . 2 d )$$

Where:

_{g}=Subscript denoting a group of households with similar characteristics.

HH=Number of households in a particular group.

AES=Average energy savings of a home in group _{g}

### Data Collection, Testing, and End Use Metering for Appliance Programs

Depending on the calculation methodology used, different sets of information may be required. The data collection methodology, therefore, may be based on the calculations' input requirements. The key input variables may include:

1. Energy: the energy consumption of the device may be measured with energy consumption meter (to spot test or sub-meter), may be collected from utility bills, or may be derived from other appropriate source(s).

2. Wattage: the power demand (kW) of the device for a given unit of time and use may be measured with watt meters (to either spot test or sub-meter the appliance), from inspecting the device's nameplate capacity, or other appropriate means.

3. Usage: the number of hours the device is “on” may be measured with time of use loggers, or other appropriate means.

Measurements may be taken according to industry-accepted standards/practices. Records may be maintained, indicating the method of test or measurement standard used. Relevant standards and codes may include older, current, more recent or replacement versions of:

Household Refrigerators, Combinations Refrigerator-Freezers, and Household Freezers (AHAM, American National Standards Institute(ANSI)/AHAM; HRF 1);

Household Refrigerators and Freezers (Canadian Standards Association (CSA) C22.2 No. 63-M1987); and

Capacity Measurement and Energy Consumption Test Methods for Refrigerators, Combination Refrigerator-Freezers, and Freezers (CSA, CAN/CSA C3 OO-M91); each of which is incorporated herein by reference.

### Energy Efficient Domestic Water Heating Programs

Domestic hot water (DHW), such as electric or gas, consumes energy by heating water for showers, baths, and other household uses. Improvements in domestic hot water systems of homes may result in substantial energy savings. For example, an oil-fired boiler could be replaced with a natural gas hot water heater.

$$Household Energy Consumption = ( WC * SpH * Δ T ) / Eff \qquad ( Eq . 3 a )$$

Where:

WC=Amount of water consumed (in kg) during the period under consideration.

SpH=Specific heat capacity of water (4.184 J g⁻¹ ° C.⁻¹).

ΔT=Difference between the inlet and outlet water temperature (in degrees Celsius).

Eff=Overall operating efficiency of the water heating device.

The net energy savings from a whole home DHW upgrade may be calculated as in Equation 1d. In particular, household energy consumption for a baseline and for post-implementation may be calculated. Net energy savings may be calculated as the difference between the two. The program-wide energy savings may be determined by summing savings in each household, as represented in Equation 1e or 1f.

### Data Collection, Testing, and End Use Metering for Domestic Hot Water Heating Programs

Depending on the calculation methodology used, different sets of information may be required. Consequently, the data collection methodology may be based on the calculations' input requirements. The key input variables may include:

1. Energy: the energy consumption of the installation may be measured with kWh meter (to spot test or sub-meter), utility bill records, sub-system consumption monitoring, or other appropriate means.

2. Efficiency: the system efficiency may be found from manufacturer's specifications, tested according to the appropriate American Society of Heating, Refrigerating, and Air-Conditioning Engineers (ASHRAE) standards indicated below, or other appropriate means.

3. Consumption: the household water consumption may be monitored using flow meters, may be based on ASHRAE estimates, or other appropriate means.

4. Temperature: water temperature may be measured using thermometers, may be based on assumptions found in the ASHRAE Fundamentals Handbook, or other appropriate means.

Measurements may be taken according to industry-accepted standards/practices. Records may be maintained comprising the method of test or measurement standard used. Relevant standards and codes may include older, current, more recent, or replacement versions of:

Oil-fired Steam and Hot-Water Boilers for Residential Use (CSA. B140.7.1-1976 (R 1991);

Gas Appliance Thermostats (AGA, ANSI Z21.23-1989; Z21.23a-1991);

Hot Water Immersion Controls (NEMA, NEMA DC-12-1985 (R 1991));

Method of Testing to Determine the Thermal Performance of Solar Collectors (ASHRAE, ANSI/ASHRAE 93-1986 (RA 91));

Methods of Testing to Determine the Thermal Performance of Solar Domestic Water Heating Systems (ASHRAE, ASHRAE 95-198 1 (RA 87));

Methods of Testing for Rating Residential Water Heaters (ASHRAE, ANSI/ASHRAE 118.1-1993); and

Methods of Testing for Rating Combination Space Heating and Water Heating Appliances (ASHRAE, ANSI/ASHRAE 124-1991);

each of which is incorporated herein by reference.

### Energy Efficient HVAC Programs

Residential heating, ventilation, and/or air conditioning (HVAC) systems maintain comfortable temperatures. The demands placed on a particular HVAC system may be dependent not only on the weather but also on how well the home is insulated and the demands of the occupants. In geographic regions where the exterior environment is uncomfortable for much of the year (whether for heating or cooling), improvements in HVAC systems may have the potential for substantial energy savings.

### Energy Savings Equations for HVAC Programs

In cases where HVAC energy end use consumption is metered, energy savings may be calculated from the following equation:

$$Household Energy Savings = ( {EC}_{b} / ( {WI}_{b} * {OBI}_{b} ) - {EC}_{pi} / ( {WI}_{pi} * {OBI}_{pi} ) ) * {OBI}_{pi} * {WI}_{pi} \qquad ( Eq . 4 a )$$

Where:

EC=Household energy consumption (as measured in kWh).

WI=Weather index.

OBI=Occupant behavior index.

_{b}=Subscript denoting the baseline (without EE program) scenario.

ₚᵢ=Subscript denoting the post-implementation (with EE program) scenario.

In cases where sub-metered energy consumption is not available, energy consumption and household energy savings may be alternatively calculated using the two equations below:

$$\begin{matrix}Household Energy Consumption = DD * 24 * 1 / Eff * RC / ( {DT}_{indoors} - {DT}_{outdoors} ) & ( Eq . 4 b ) \\ Household Energy Savings = {EC}_{b} - {EC}_{p i} & ( Eq . 4 c )\end{matrix}$$

Where:

DD=Heating degree days (HDD) or cooling degree days (CDD), as appropriate.

Eff=Overall device efficiency rating.

RC=Rated capacity of the device.

DT=Design temperature.

EC=Household energy consumption (as measured in kWh).

_{b}=Subscript denoting the baseline (without EE program) scenario.

ₚᵢ=Subscript denoting the post-implementation (with EE program) scenario.

The total net energy savings from the energy efficiency program may be determined by summing savings in each household, calculated as shown in Equations 1e and 1f.

### Data Collection, Testing and End Use Metering for HVAC Programs

Depending on the calculation methodology used, different sets of information may be required. Consequently, the data collection methodology may be based on the calculations' input requirements. The key input variables may include:

1. Energy: the energy consumption of the device may be measured with kWh meter (to spot test or sub-meter), or may be collected from utility bills, or other appropriate means.

2. Wattage: the power demand (kW) of the device for a given unit of time and use may be measured with watt meters (to either spot test or sub-meter the appliance), or from inspecting the device's nameplate capacity, or other appropriate means.

3. Usage: the number of hours the device is “on” may be measured with time of use loggers, or other appropriate means.

4. Heating Degree Days and Cooling Degree Days: a measure of heating or cooling load on a facility created by an outdoor temperature. When the mean daily outdoor temperature is one degree below a stated reference temperature such as 1° C., for one day, it is defined that there is one heating degree day. If this temperature difference prevailed for ten days there would be ten heating degree days counted for the total period. If the temperature difference were to be 12° for 10 days, 120 heating degree days would be counted. When ambient temperature is below the reference temperature, heating degree days are counted; when ambient temperatures are above the reference, cooling degree days are counted. Any reference temperature may be used for recording degree days, usually chosen to reflect the temperature at which heating or cooling is no longer needed. Many utilities operate weather stations that record this information. The National Oceanographic and Atmospheric Agency also gathers this information (http://www.ncdc.noaa.gov/).

5. Rated Capacity (Btu/hr): the rated capacity may be found from manufacturer's specifications, or tested according to the appropriate ASHRAE standards indicated below, or other appropriate means.

6. Efficiency: the system efficiency (whether AFUE or SEER) may be found from manufacturer's specifications, or may be tested according to the appropriate ASHRAE standards indicated below, or other appropriate means.

7. Design Temperature (T_{design,indoor} and T_{design,outdoor}): design temperatures may be specified in the ASHRAE Fundamentals Handbook or by local code organization (state building codes, etc.), or from other appropriate means.

Measurements may be taken according to generally-accepted standards and/or practices. Records may be maintained comprising the method of test or measurement standard used. Relevant standards and codes may include older, current, more recent, or replacement versions of:

Air Conditioning:

HVAC Systems—Testing, Adjusting and Balancing (1993) (Sheet Metal and Air Conditioning Contractors' National Association (SMACNA));

Determining the Required Capacity of Residential Space Heating and Cooling Appliances (CSA, CAN/CSA-F280-M90);

Load Calculation for Residential Winter and Summer Air Conditioning, 7th Ed (1986) (ACCA, ACCA Manual J);

Methods of Testing for Seasonal Efficiency of Unitary Air Conditioners and Heat Pumps (ASHRAE, ANSI/ASHRAE 116-1983);

Heat Pump Systems: Principles and Applications (Commercial and Residence) (ACCA, Manual H);

Method of Testing for Rating Room Air Conditioners and Packaged Terminal Air Conditioners (ASHRAE, ANS1/ASHRAE 16-1983 (RA 88));

Method of Testing for Rating Room Air Conditioners and Packaged Terminal Air Conditioner Heating Capacity (ASHRAE, ANSI/ASHRAE 58-1986 (RA 90));

Methods of Testing for Rating Room Fan-Coil Air Conditioners (ASHRAE, ANSI/ASHRAE, 79-1984 (RA 91));

Methods of Testing for Rating Unitary Air-Conditioning (ASHRAE, ANSI/ASHRAE 37-1988);

Room Air Conditioners (Underwriters' Laboratories (UL), UL 484);

Ducts:

Duct Design for Residential Winter and Summer Air Conditioning (ACCA. Manual D);

HVAC Air Duct Leakage Test Manual (1985) (SMACNA, SMACNA);

Pipes, Ducts and Fittings for Residential Type Air Conditioning Systems (CSA, B228.1-1968);

Heating:

HVAC Systems—Testing, Adjusting and Balancing (1993) (SMACNA, SMACNA);

Installation Standards for Residential Heating and Air Conditioning Systems (1988) (SMACNA, SMACNA);

Residential Equipment Selection (ACCA, Manual S);

Determining the Required Capacity of Residential Space Heating and Cooling Appliances (CSA, CAN/CSA-F280-M90);

Oil-fired Steam and Hot-Water Boilers for Residential Use (CSA, B140.7.1-1976 (R 1991);

Gas Appliance Thermostats (AGA, ANSI Z21.23-1989; Z21.23a-1991);

Heat Pump Systems: Principles and Applications (Commercial and Residence) (ACCA, Manual H);

Methods of Testing for Annual Fuel Utilization Efficiency of Residential Central Furnaces and Boilers (ASHRAE, ANSI/ASHRAE 103-1993);

Methods of Testing for Rating Unitary Air-Conditioning and Heat Pump Equipment) (ASHRAE, ANSI/ASHRAE 37-1988);

Requirements for Residential Radiant Tube Heaters (AGA, 7-89);

Installation Guide for Residential Hydronic Heating Systems, 6th ed. (1988) (HYDI, IBR 200); and

Methods of Testing for Performance Rating of Wood burning Appliances (ASHRAE, ANSI/ASHRAE 106-1984);

each of which is incorporated herein by reference.

### Energy Efficient Lighting Programs

Adequate lighting typically is a necessity in living and working environments. Many spaces, such as hallways, may require twenty-four hour illumination. Lighting upgrades, therefore, may have substantial potential to reduce energy consumption, especially in situations where lights are on for extended periods of time. Improvements in lighting efficiencies also may lead to reduced cooling loads, because inefficient lights cause electrical energy to be converted to heat instead of light.

In cases where wattage is constant (i.e., non-variable light systems), the energy consumption may be calculated from the following equation:

$$Household Energy Consumption = ( k {W}_{b} - k {W}_{p i} ) * t \qquad ( Eq . 5 a )$$

Where:

kW=reported energy demand (in kilowatts).

_{b}=Subscript denoting the baseline scenario.

ₚᵢ=Subscript denoting the post-implementation scenario.

t=duration of time over which the lighting system is active.

The baseline scenario for lighting upgrade programs may comprise the continued use of a current lighting system or comparable standard replacement systems (assuming no energy efficiency program is in place). Post-implementation energy consumption may be calculated from accurate on-site metering, by multiplying the duration of usage by an accepted standard rate of energy consumption for a particular system, or by other appropriate means. Equation 5a is calculable only when the wattage of the lights is fixed (the lights are not dimmable) and the number of hours is known.

When lights are dimmable or when it is possible to monitor the system-specific energy consumption, the energy consumption, (pre- or post-implementation) may be calculated as presented in Equation 1c. Net household energy savings may be calculated as shown in Equation 1d, and program-wide energy savings may be calculated as in Equations 1e and 1f.

### Data Collection, Testing, and Sub-Metering for Lighting Programs

Depending on the calculation methodology used, different sets of information may be required. Consequently, the data collection methodology may be based on the calculations' input requirements. The key input variables may include:

1. Energy: the energy consumption of the installation may be measured with kWh meter (to spot test or sub-meter), or sub-system consumption monitoring, or other appropriate means.

2. Wattage: the power demand (kW) of the device for a given unit of time and use may be measured with watt meters (to either spot test or sub-meter the installations), or from inspecting the rating on the installed bulb and the ballast's nameplate capacity, or from other appropriate means.

3. Usage: the number of hours the installation is “on” may be measured with time of use loggers, or other appropriate means.

Measurements may be taken according to generally-accepted standards and/or practices. Records may be maintained comprising the method of test or measurement standard used. Relevant standards and codes may include older, current, more recent, or replacement versions of:

Illuminating Engineering Society Lighting Handbook, 8th Edition, Illuminating Engineering Society of North America, 1993;

Economic Analysis of Lighting, Illuminating Engineering Society of North America;

ASHRAE/IES Standard 90.1-1989, American Society of Heating Refrigerating and Air-Conditioning Engineers (ASHRAE) and Illuminating Engineering Society (IES), 1989;

Advanced Lighting Guidelines: 1993, Electric Power Research Institute (EPRI)/California Energy Commission (CEC)/United States Department of Energy (DOE), May 1993;

Lighting Upgrade Manual. US EPA Office of Air and Radiation 6202J. EPA 430-B-95-003 January 1995;

Calculation Procedures and Specification of Criteria for Lighting Calculations, Illuminating Engineering Society of North America;

Determination of Average Luminance of Indoor Luminaires, Illuminating Engineering Society of North America;

Design Criteria for Interior Living Spaces ANSI Approved, Illuminating Engineering Society of North America; and

Lighting Fundamentals Handbook, Electric Power Research Institute, TR-101710, March 1993;

each of which is incorporated herein by reference.

### Fuel Switching Programs

Fuel switching may include changing from a more-polluting to a less-polluting fuel. Most combustible fuels, while producing energy, result in a range of air pollutants. Increasing the efficiency of a device or system may reduce emissions, so too changing to a “cleaner” fuel may reduce emissions. Fuel switching improvements may include use of a specific fuel (e.g., switching from coal with a high sulfur content to coal with a low sulfur content) or switching to a different fuel type (e.g., switching from fuel oil to natural gas). Other cleaner fuel sources may include solar, heat pump, geothermal, methane, and a variety of others. Fuel switching changes the emission factors for the device and may also result in a greater operating efficiency. Maintenance may also be done on the device while doing the fuel conversion.

Fuel switching emissions reductions may be calculated from the following equation:

$$Emission Reduction = {EC}_{bi} * {EF}_{bi} - {EC}_{pi} * {EF}_{pi} \qquad ( Eq . 6 a )$$

Where:

EC_{bi}=energy consumption for the baseline.

ECₚᵢ=energy consumption after the program.

EF_{bi}=Marginal Emission Factor during the baseline.

EFₚᵢ=Marginal Emission Factor after the program.

Emission factors may be calculated for both the baseline case and the upgrade, due to the different operating efficiencies and pollution emission rates.

### Data Collection, Testing, and End Use Metering for Fuel Switching Programs

Changing fuel sources typically impacts a home's space heating and cooling systems (HVAC), and related emissions factors. The emissions factors may be calculated as previously described under “Emissions Factors.”

### Energy Efficient Whole House Programs

Whole home upgrades may increase home insulation and decrease both infiltration of outside air (cold air in winter and hot air in summer) and leakage of inside air (warm air in winter and cool air in summer). Such renovations may include, but are not limited to: installing insulation in attics and exterior walls; installing more efficient windows and/or doors; reducing infiltration; and any other appropriate improvements. Whole home energy consumption may be highly dependent on the exterior environment and therefore, it may be advantageous to normalize the result using a weather index for the local environment, when possible.

The net energy savings from a whole home upgrade may be calculated as in Equation 7a. The program-wide energy savings may be determined by summing savings in each household, as presented in Equation 7b.

$$Net Energy Savings = ( {EC}_{b} / {OBI}_{b} - {EC}_{pi} / {OBI}_{pi} ) * {OBI}_{pi} \qquad ( Eq . 7 a )$$

Where:

EC=Energy Consumption.

_{b}=Subscript denoting the baseline scenario.

ₚᵢ=Subscript denoting the post-implementation scenario.

OBI=Occupant behavior index.

$$Total Program Energy Savings = \sum ( {HH}_{g} * {AES}_{g} ) \qquad ( Eq . 7 b )$$

Where:

_{g}=Subscript denoting a group of households with similar characteristics.

HH=Number of households in a particular group.

AES=Average energy savings of a home in group _{g}.

### Data Collection, Testing, and Sub-Metering for Whole House Programs

Depending on the calculation methodology used, different sets of information may be required. Consequently, the data collection methodology may be based on the calculations' input requirements. The key input variables may include:

1. Energy: the energy consumption of the installation may be measured with kWh meter (to spot test or sub-meter); utility bill records; sub-system consumption monitoring; or other appropriate means.

2. Building Insulation: insulation levels may be gathered from construction records or may be estimated based on the building's age, building type, or other appropriate means.

3. Infiltration: testing for infiltration may be conducted with a Minneapolis blower door or other suitable product. Testing may be undertaken by a trained and experienced technician, according to the relevant standards.

Modification of a building's thermal envelope may impact primarily on the home's space heating and space cooling loads.

Measurements may be taken according to generally-accepted standards and/or practices. Records may be maintained comprising the method of test or measurement standard used. Relevant standards and codes may include older, current, more recent, or replacement versions of:

Air leakage Performance for Detached Single-Family Residential Buildings (ASHRAE, ANSI/ASHRAE 119-1988);

Methods of Determining Air Change Rates in Detached Dwellings (ASHRAE, ANSI/ASHRAE 136-1993);

Methods of Testing for Room Air Diffusion (ASHRAE, ANSI/ASHRAE 113-1990);

Ventilation for Acceptable Indoor Air Quality (ASHRAE, ANSI/ASHRAE 62-1989);

Model Energy Code (1992) (Council of American Building Officials (CABO));

Thermal Environmental Conditions for Human Occupancy (ASHRAE, ANSI/ASHRAE 55-192); and

Energy Conservation in New Building Design Residential only (ASHRAE, ANSI/ASHRAE/IES 90A-1980);

each of which is incorporated by reference. Other energy efficient upgrade or improvements are considered to be well within the scope of the present invention.

### Quantification of Emissions Reductions

Emission reductions are a function of their associated emission factors and energy savings. Reductions in emissions of a gas may be calculated from the following equation:

$$Reduction in Emissions of gas g = {\sum }_{p = 1}^{n} ( {ES}_{p , g} * {EF}_{p , g} ) \qquad ( Eq . 8 a )$$

Where:

ₚ=Subscript denoting the implemented project, or specific efficiency-improving measure.

ₙ=Number of contributing energy efficiency programs.

ES=Energy saved from project ₚ, expressed in kWh (kilowatt-hours).

EF=Emission factor associated with g, expressed as tons carbon equivalent (TCE) per kWh.

g=Gas.

The relevant emission factors may vary over time. Embodiments of the present invention also contemplate incorporating a changing emission factor into the above equation.

### Quantification of Tradable Emissions Reductions

Emissions reductions from an energy efficiency program may be calculated in step 200 based on the predicted energy savings and relevant emission factors. Uncertainties are associated with both the energy savings and the emission factor estimates. Embodiments of the present invention include a set of procedures for assessing the level of uncertainty in these estimates and the assignment of TCFs to each (see below). A purpose of the TCFs is to determine a portion of the calculated emissions reduction that is certain (or tradable) from the portion that is uncertain (or untradable). The uncertain portion of the emissions reductions may be held in reserve and may be released in future years, if verified.

Although it is possible to offer tradable emissions reductions within the scope of the present invention with a specified degree of uncertainty (e.g. 1,000 metric tonnes of CO₂±10%), embodiments also contemplate offering tradable emissions reductions without uncertainty (e.g. 1,000 metric tonnes of CO₂). It may be desirable to calculate the emissions reductions that are guaranteed to occur, despite any uncertainty in the calculations (or estimation process). For example, if the calculated emissions reductions for a given energy efficiency program were 1,000 metric tonnes with an uncertainty of ±10%, only 900 metric tonnes may be considered tradable. According to an embodiment of the present invention, a method for calculating a tradable portion of the emissions is presented in Equation 9a.

$$Tradable Emissions Reductions = Emissions Reductions * TCF \qquad ( Eq . 9 a )$$

Where:

TCF=Technical Confidence Factor

TCF may be a number from 0 to 1 (or other appropriate scale) that captures the uncertainty in both the energy savings and emissions factor estimates. A high TCF (approaching 1) indicates that there is very little uncertainty in the calculated emission reductions and, therefore, the size of the tradable emissions reductions pool is almost the same size as the calculated emissions reductions. A low TCF (approaching 0) indicates that there is substantial uncertainty and the tradable emissions reductions, therefore, are only a small portion of the calculated emissions reductions.

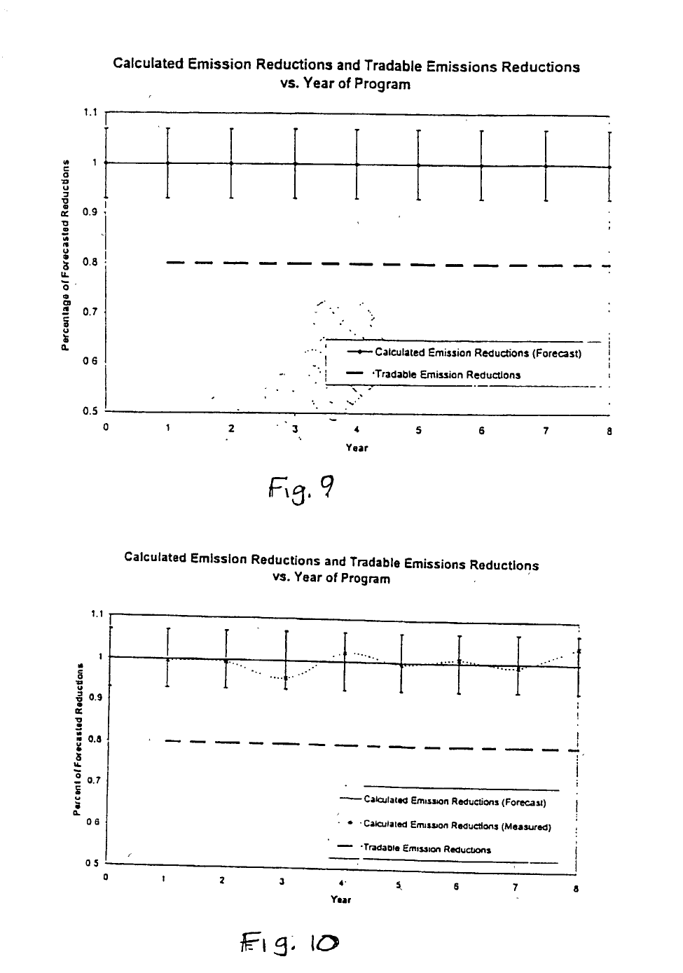

The graph in FIG. 9 presents an example of predicted emissions reductions from the calculations (Equations 2-7 above) and tradable emissions reductions. The vertical error bars show the uncertainty. A TCF may be identified and used on the calculated emissions reductions to produce the tradable emissions reductions (the horizontal dashed line in FIG. 9).

In a forecasting phase of the M&V process, the emissions reduction potential may be predicted, or estimated. This is shown as the solid horizontal line in FIG. 9. Based on the anticipated measurement approach to be used in the program phase of an M&V process, uncertainty of the measured emissions reduction results may be estimated. This uncertainty is shown by the vertical error bars. The uncertainty bars indicate the portion of the estimated emissions reduction that is certain (i.e., the region below the error bars) and uncertain (the region within the error bars). This general approach may be used to determine a TCF for each of several M&V approaches.

As data are collected on the emissions reductions from a given energy efficiency program during the program phase of the M&V process, the measured data are expected to agree with forecasted emissions reductions predicted in the forecasting phase, albeit with some degree of variability. A purpose of TCFs is to ensure that the measured emissions reductions (the fluctuating dotted line in FIG. 10) always exceed the “tradable emissions reduction” (i.e., are reliable estimates).

In an embodiment of the present invention, data may be entered by a program participant (e.g., program partner) into electronic spreadsheets that automatically calculate emissions reductions and tradable emissions reductions for a program. Data entered into the electronic spreadsheet(s) may include, but is not limited to: energy consumption; emissions factors; and M&V options. The spreadsheet(s) may be adapted to provide a number of options to the participant, allowing the participant to select the most relevant options. For example, a participant may select a default emissions factor or may enter its own emissions factor. Once the applicable data is entered, the spreadsheet may automatically perform the various calculations through linked algorithms. Electronic spreadsheets may be provided by suitable software, such as, for example, Excel spreadsheets. Alternatively, data may be entered into hardcopy versions of spreadsheets without automatic calculations of emissions reductions and tradable emissions reductions.

### Future Options

At the mid-point, or any other appropriate point, in the “lifetime” of a set of energy efficiency programs, the actual emissions reductions may consistently exceed the tradable emissions. In this case, emissions reductions forecasts and TCFs may be overly conservative. Consequently, greater emissions reductions were realized than were offered in the pool of tradable emissions reductions. FIG. 11 shows how a new pool of tradable emissions reductions (depicted as Tradable Emissions Reduction 2) may be formed from the un-traded (or untapped) emissions reductions from these energy efficiency programs. The new pool may be formed from actual field measurements of energy savings and resulting emissions reductions.

### Calculation of TCFs

A method for assessing tradable emissions is provided in Equation 9a. The TCF may be determined based on the sum of three other factors, as in the following equation.

$$\begin{matrix}TCF = Technical Confidence Factor \\ TCF = 1 - ( {RF}_{ES} + {RF}_{EF} + AF )\end{matrix} \qquad ( Eq . 9 b )$$

Where:

RF_{ES}=Risk Factor for Energy Savings Estimates

RF_{EF}=Risk Factor for Emission Factors Estimates

AF=Adjustment Factor

These factors are defined below.

### Identification of Risk Factors for Energy Consumption (RF_{ES})

Risk factors factor in uncertainty in the calculations used to derive the calculated emissions reductions. A risk factor is, therefore, a function of the type of program (such as HVAC or lighting), and the rigor used to verify the energy savings and emission factors. The rigor of an energy savings program is dependent on the type of measurement approach method used, and the scale at which these methods are undertaken. Possible measurement approaches include: Energy Star; engineering calculations/modeling; billing analysis; metering/sub-metering, and/or other appropriate means.

The Energy Star label may be employed to provide credible monitoring and verification procedures for each of the various programs it covers (e.g., appliances, homes). Default values for different programs may be provided. If a participant's program is based on Energy Star, the default values and associated risk factors may be used.

Energy savings values may be based on other sources, such as, for example, previously published studies or statistics. These estimates may be regional or local and may be from a number of different sources, whether governmental, academic, private, or other sources. Risk factors associated with several types of outside sources are presented in Table 1.

Energy savings and emissions reductions may also be quantified using engineering estimates, or computer models, or other appropriate means. This may include simple degree day analysis, bin analysis, hourly modeling, and/or time-step analysis with building energy software (such as DOE-2, EnergyPlus, or any other suitable software). Sample risk factors for different engineering calculation methods at different scales of measurement (the number of homes and weather scenarios examined) are shown in Table 2.

Billing analysis may be performed by analyzing large samples of measured data from program participants and control groups to quantify the shift in energy consumption due to program participation. This analytical methodology may be performed on raw data or on data that is normalized and stratified by relevant factors (such as weather and group characteristics). Sample risk factors, for different billing analysis methods, at different scales of inspection (the percentage of homes examined), are presented in Table 3.

Metering and sub-metering may be used to measure the consumption in those end-uses affected by a given energy efficiency program. Sample risk factors for different metering and sub-metering analysis methods, at different scales of inspection (the percentage of homes examined), are shown in Table 4.

TABLE 1
Risk Factors
For Other Sources (Published)

| Methodology | Risk Factors |
|---|---|
| Utility Estimates (based on previous | 0.25 |
| published studies) | |
| Energy Star Labeled Homes | 0.07 |

TABLE 2
Risk Factors
For Engineering Estimates and Modeling

| | Risk Factors | | |
|---|---|---|---|
| | No. of Buildings/Weather | | |
| | Scenarios Considered | | |
| Methodology | 1-5 | 6-10 | 11-20 |
| Simplified Energy Calculations | 0.25 | 0.21 | 0.11 |
| Simplified Energy Calculations with | 0.21 | 0.14 | 0.07 |
| field inspection | | | |
| Detailed Energy Calculations | 0.21 | 0.14 | 0.07 |
| Detailed Energy Calculations with field | 0.11 | 0.07 | 0.04 |
| inspection | | | |

| | |
|---|---|
| Calculations on Home Characteristics | 0.20 |
| (defaults) | |

TABLE 3
Risk Factors
For Billing Analysis

| | Risk Factors | | | |
|---|---|---|---|---|
| | % Sampling | | | |
| Methodology | 5% | 10% | 25% | 100% |
| Raw data analyzed | 0.25 | 0.21 | 0.11 | 0.07 |
| Data normalized by weather | 0.21 | 0.14 | 0.07 | 0.04 |
| Data are stratified (grouped by | 0.21 | 0.14 | 0.07 | 0.04 |
| appropriate characteristics before | | | | |
| analysis) | | | | |
| Stratified and weather normalized | 0.11 | 0.07 | 0.04 | 0.02 |

TABLE 4
Risk Factors
For Metering/Sub-Metering

| Emission Factor Source | Risk Factors |
|---|---|
| Regional/multi-state average | 0.2 |
| (published) | |
| State historical average | 0.15 |
| Utility 5-year forecast | 0.1 |
| Third party analysis of utility (including | 0.05 |
| 5-year forecast) | |

### Identification of Risk Factors for Emission Factors (RF_{EF})

Once energy savings are calculated, emission factors may be used to convert these savings into emissions reductions. Emission factors typically have some uncertainty, based on the method of measurement and the resolution of the data (national, state, utility, or plant specific). Sample risk factors for emission factors based on different quantification methodologies are presented in Table 5.

TABLE 5
Risk Factors
For Emission Factors

| | Type of Plan | | |
|---|---|---|---|
| | 3 year Historical | | |
| Methodology | Trend¹ | 2-4 Year Plan² | 6-8 Year Plan³ |
| Default/E-Grid⁴ | 0.45 | — | — |
| Utility Estimate⁵ | 0.55 | 0.65 | 0.75 |
| 3^{rd} Party⁶ | 0.65 | 0.75 | 0.85 |

Notes:
¹Historical emission factors are used to predict future emissions.
²The utility's plans for generation capacity are used to develop a 2-4 year estimate of emissions.
³The utility's plans for generation capacity are used to develop a 6-8 year estimate of emissions.
⁴EPA's emission factor database (E-grid) is used to estimate emission factors.
⁵The utility estimates emission factors.
⁶Outside consultants are used to calculate the utility's emission factors.

### Identification of Adjustment Factors (AF)

Uncertainty may be related to future energy use patterns (e.g., due to unexpected changes in energy costs or weather) and emission factors (e.g., due to unexpected changes in regulations). Such changes may be difficult to anticipate and could affect emissions reductions achieved in a given year. To provide a buffer for these future possibilities, an Adjustment Factor (AF) may be incorporated into a TCF. An AF may be assigned a value corresponding to the total emissions reductions available, such as, for example 15%. An assigned value may be periodically revisited and updated. An AF ensures that the tradable emissions reductions do not exceed the actual emissions reductions achieved by a program. If an overall TCF is shown to be too conservative, the excess emissions reductions may be included in future emission pools. Alternatively, if the actual emissions reductions are shown to align with the tradable emissions reductions, the overall TCF has effectively performed its function of protecting the financial interests of an ETI's participants.

### Monitoring of Energy Savings and Quantification of Emissions Reductions

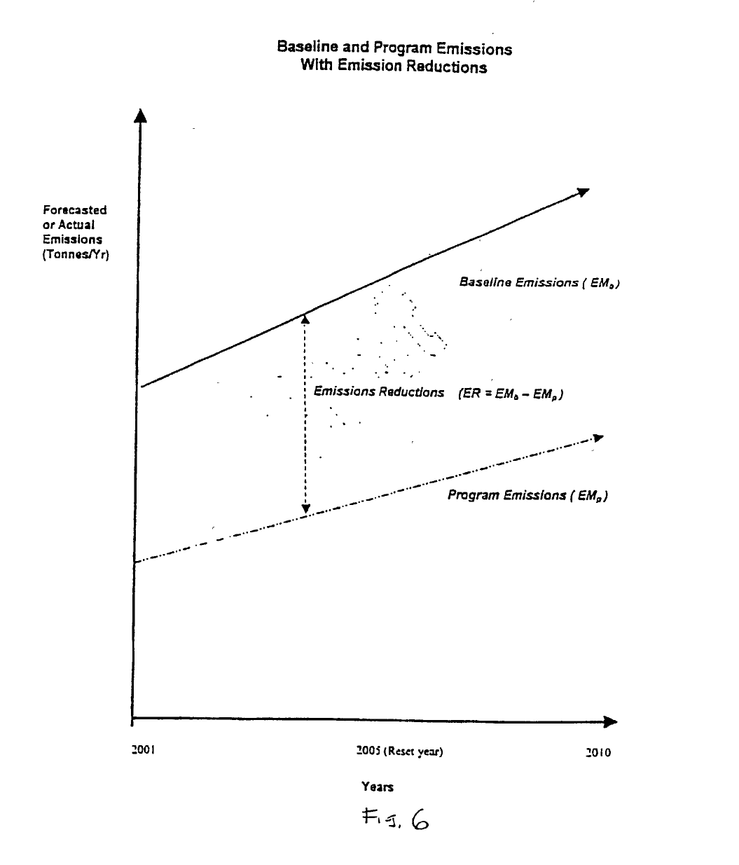

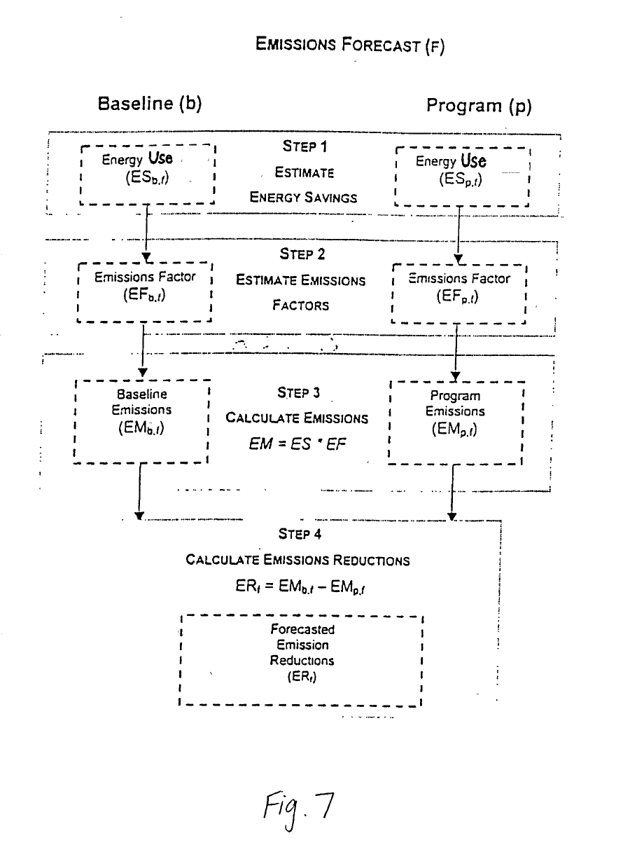

In the early stages of an energy savings program, emissions reductions may be predicted years into the future. This involves making a number of assumptions about energy consumption and emission factors. This forecasting phase is outlined in FIG. 7.

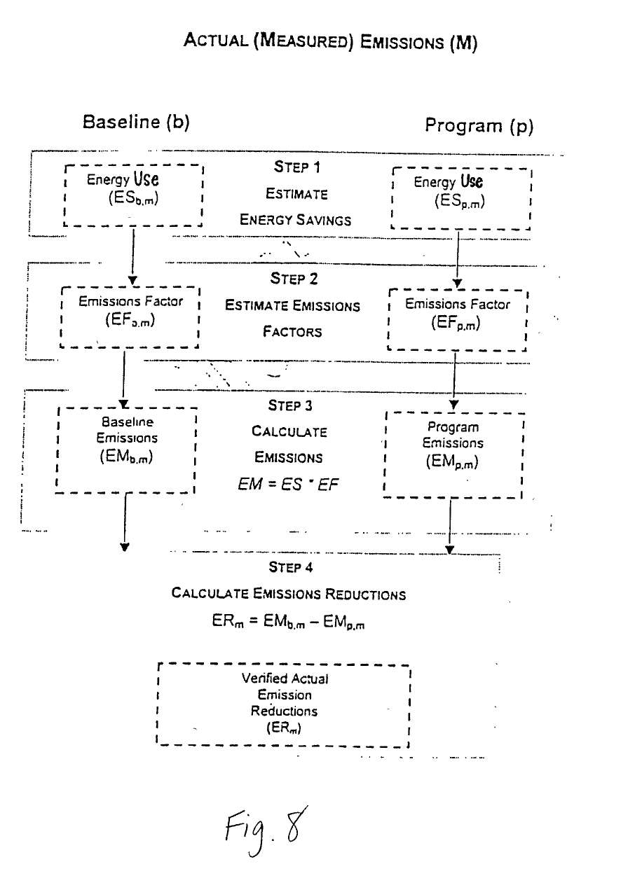

Once one or more energy savings opportunities have been implemented, actual energy consumption and emission factors may be measured, providing estimates of actual emissions reductions. This measurement phase is shown in FIG. 8. In the steps of monitoring the residential energy savings opportunities 400 and monitoring the quantification of the emissions reduction 500, as depicted in FIG. 2, program participants, such as program administration staff, may compile and manage the energy savings and emissions reductions data measured and collected by program partners.

### Verification of Energy Savings

In step 600, as depicted in FIG. 2, quantification of the emissions reduction may be verified. As described above, an initial estimate of energy savings may be calculated based on an assessment of the difference between baseline energy use and post-implementation or measured energy use.

Baseline forecasts may be constructed from historical records of energy consumption and use. When historical information is not available, field monitoring or other appropriate means may be employed. Post-implementation energy use may be measured, or may be estimated through engineering calculations, deemed savings estimates, or other appropriate means. Deemed savings estimates may be used for energy efficient technologies that are well-understood and on which there is general agreement on the energy use and savings that can be achieved (e.g., many electric appliances). Deemed savings may be calculated by using a device's power output and length of use. Deemed savings may be used when a device is used for predictable time periods and energy consumption does not vary. For example, deemed savings could be used with lights that are on 24 hours a day, 365 days a year (the energy consumption may be calculated with reasonable certainty due to the consistent demand and length of use).

After installation of the measures, baseline energy use and post-implementation energy use may be verified through field monitoring, deemed savings estimates, or other appropriate means. Net energy savings may be calculated by subtracting post-implementation energy use from baseline energy use. In cases where energy consumption is highly dependent on external variables (such as an HVAC system's dependence on weather), energy consumption may be normalized for such variables.

### Verification of Emissions Reductions

Step 600 may further comprise verifying the emissions reductions for energy savings opportunities or energy efficiency programs. Baseline emissions and emission reductions that result from implementation of a project may be calculated from energy consumption and savings data. The translation from energy use/savings to emissions/reductions may be based on emission factors appropriate to the device and fuel source (e.g., gas, oil, electric) being examined. In an embodiment of the present invention, a methodology is used to determine emission factors based on U.S. EPA's “Compilation of Air Pollutant Emission Factors” (AP-42), or any subsequent revision or replacement. After energy consumption has been calculated for the baseline and upgrade scenarios, an emission factor database may be used to calculate the emissions reductions of the program.

In step 600, calculations and estimates undertaken in the measurement phase may be used to verify that the emissions reductions predicted in the forecasting phase are achieved. Verification may afford the emissions reduction purchaser confirmation that the reductions are genuine. This process may support the value of the emissions reductions in the marketplace. Self-verification by program participants and/or third party verification may be employed. If measured emissions reductions are significantly different from forecasted emissions reductions, then reconciliation may be needed. For example, a program partner may recalculate and resubmit new estimations of its tradable emissions reductions.

Energy savings may be calculated from analysis of historical energy consumption and modeling of future consumption. These calculations will have a degree of uncertainty and may be verified after the program has been in place for a length of time, thereby allowing actual consumption to be measured from utility bills, metering devices, and/or other appropriate means.

### Uncertainty

As described above, a degree of uncertainty is involved in energy savings and thus emissions reductions calculations. Statistical methods may be used in calculating energy savings in step 200 to determine the results of a particular residential energy saving program and to help secure confidence and financing for a residential emission trading credit program embodying the present invention. The M&V protocol of the present invention may further comprise statistical means, such as confidence levels and sampling. Methods for applying the following statistical equations are known in the art of error and risk analysis. Uncertainty analysis may also employ methods described in the International Performance Measurement & Verification Protocol, Appendix B, which is incorporated herein by reference.

A certain degree of uncertainty is inherent in many measurements, estimations, and forecasts. Sources of uncertainty include, for example, instrumentation error, modeling error, sampling error, and other systematic and/or random errors. The magnitude of errors typically is given by manufacturer's specifications. Typically, instrumentation errors are small, and are not believed to be a major source of error in estimating savings. Nonetheless, they too may be considered where appropriate.

Modeling error refers to errors in the models used to estimate parameters of interest. Biases may arise from model miss-specification, including, but not limited to: omitting important terms from the model; assigning incorrect values for “known” factors; and extrapolation of the model results outside their range of validity. Random effects of factors not accounted for by the model variables are non-systematic errors.

Various regression (linear and/or non-linear) and/or correlation functions may be employed in the models of the present invention. Regression models are inverse mathematical models that describe the correlation of independent and dependent variables. Linear regressions may be employed of the form:

$$Y = {b}_{0} + {b}_{1} {x}_{1} + {b}_{2} {x}_{2} + … + {b}_{p} {x}_{p} + e \qquad ( Eq . 10 a )$$

Where:

y and xₖ, k=1, 2, 3, . . . , p observed variables.

bₖ, k=0, 1, 2, . . . , p coefficients estimated by the regression.

e=Residual error not accounted for by the regression equation.

Methods for applying this and the following equations, and the variables used therein, are known by those of ordinary skill in the art. Models of this type may be used in two ways:

1. To estimate the value of y for a given set of x values. An example of this application is the use of a model estimated from data for a particular year or portion of a year to estimate consumption for a normalized year.

2. To estimate one or more of the individual coefficients bₖ.

In the first case, where the model is used to predict the value of y given the values of the xₖ's, the accuracy of the estimate may be measured by the root mean squared error (RMSE) of the predicted mean. This accuracy measure is provided by most standard regression packages. The MSE of prediction is the expected value of the following equation and the RMSE of prediction is the square root of the MSE.

$${( y {{\vert}_{x} - y \vert}_{x , line} )}^{2} \qquad ( Eq . 10 b )$$

Where:

y|ₓ=True mean value of y at the given value of x.

y|_{x, line}=Value estimated by the fitted regression line.

In the second case, where the model is used to estimate a particular coefficient bₖ, the accuracy of the estimate may be measured by the standard error of the estimated coefficient. This standard error is also provided by standard regression packages. The variance of the estimate b is the expected value of:

$${( b … {b}^{′} )}^{2} \qquad ( Eq . 10 c )$$

Where:

b=True value of the coefficient.

b′=Value estimated by the regression.

The standard error is the square root of the variance.

Three statistical indices may be used to evaluate regression models in embodiments of the present invention, as defined below (SAS 1990).

1. The Coefficient of Determination, R² (%)

$${R}^{2} = ( 1 - \frac{{\sum }_{i = 1}^{n} {( {y}_{pred , i} - {y}_{data , i} )}^{2}}{{\sum }_{i = 1}^{n} {( {\overline{y}}_{data} - {y}_{data , i} )}^{2}} ) \times 100 \qquad ( Eq . 10 d )$$

2. The Coefficient of Variation, CV (%):

$$CV = \sqrt{\frac{\frac{{\sum }_{i = 1}^{n} {( {y}_{pred , i} - {y}_{data , i} )}^{2}}{n - p}}{{\overline{y}}_{data}}} \times 100 \qquad ( Eq . 10 e )$$

3. Mean Bias Error, MBE (%)

$$MBE = \frac{{\sum }_{i = 1}^{n} {( {y}_{pred , i} - {y}_{data , i} )}^{2}}{\frac{n - p}{{\overline{y}}_{data}}} \times 100 \qquad ( Eq . 10 f )$$

Another form of error taken into consideration in embodiments of the present invention is sampling error. Sampling error refers to errors resulting from the fact that a sample of units was observed, rather than observing the entire set of units under study. The simplest form of sampling error is random error. A fixed number n of units is selected at random from a total population of N units. Each unit has the same probability of being included in the sample.

$$SE ( y ) = \sqrt{( 1 - \frac{n}{N} ) ( [ {\sum }_{i = 1}^{n} \frac{{( {y}_{1} - \overline{y} )}^{2}}{( n - 1 )} ]} / n ) \qquad ( Eq . 10 g )$$

Methods for applying these equations and the variables used therein are known by those of ordinary skill in the art. For more complicated random samples, more complex formulas of the type well-known in the art may be employed. In general, however, the standard error is proportional to (1/n^{0.5}). That is, increasing the sample size by a factor “f” will reduce the standard error (improve the precision of the estimate) by a factor of f^{0.5}.

### Combining Components of Uncertainty

If the savings (S) estimate is a sum of several independently estimated components (C):

$$S = {C}_{1} + {C}_{2} + {C}_{3} + {…C}_{p} \qquad ( Eq . 10 h )$$

then, the standard error of the estimate is given by:

$$SE ( S ) = {( {SE ( {C}_{1} )}^{2} + {SE ( {C}_{2} )}^{2} + {SE ( {C}_{3} )}^{2} + {…SE ( {C}_{p} )}^{2} )}^{05} \qquad ( Eq . 10 i )$$

If the savings (S) estimate is a product of several independently estimated components (C):

$$S = {C}_{1} * {C}_{2} * {C}_{3} * … * {C}_{p} \qquad ( Eq . 10 j )$$

then, the relative standard error of the estimate is approximated by:

$$\frac{SE ( S )}{S} = \sqrt{[ {( \frac{SE ( {C}_{1} )}{( {C}_{1} )} )}^{2} + {( \frac{SE ( {C}_{2} )}{( {C}_{2} )} )}^{2} + {( \frac{SE ( {C}_{3} )}{( {C}_{3} )} )}^{2} + … + {( \frac{SE ( {C}_{p} )}{( {C}_{p} )} )}^{2} ]} \qquad ( Eq . 10 k )$$

Methods for applying such equations and the variables used therein would be known by one of ordinary skill in the art.

### Uncertainty Propagation for Different Mathematical Operations

$$\begin{matrix}Operation & Z = x + y & Z = x * y & Z = {x}^{m} {y}^{n} \\ Simple Error & Δ z = \vert Δ x \vert + \vert Δ y \vert + … & \frac{Δ z}{z} = \frac{Δ x}{x} + \frac{Δ y}{y} + … & \frac{Δ z}{z} = \vert m \vert \frac{Δ x}{x} + \vert n \vert \frac{Δ y}{y} + … \\ \begin{matrix}Standard \\ Deviation \\ Error\end{matrix} & Δ z = \sqrt{{( Δ x )}^{2} + {( Δ y )}^{2} +} & \frac{Δ z}{z} = \sqrt{{( \frac{Δ x}{x} )}^{2} + {( \frac{Δ y}{y} )}^{2} +} & \frac{Δ z}{z} = \sqrt{{( \frac{m Δ x }{x} )}^{2} + {( \frac{n Δ y}{y} )}^{2} +}\end{matrix}$$

Components may be estimated independently. Independence means that whatever random errors affect one of the components are unrelated to errors affecting the other components. In particular, different components would not be estimated by the same regression fit, or from the same sample of observations.

Methods for applying the above formulae and the variables used therein would be known by those of ordinary skill in the art. The above formulae for combining error estimates from different components may serve as the basis for a propagation of error analysis. This type of analysis may be used to estimate how errors in one component may affect the accuracy of the overall estimate. Monitoring resources may then be designed cost-effectively to reduce error in the final savings estimate. This assessment may take into account:

the effect on savings estimate accuracy of an improvement in the accuracy of each component; and

the cost of improving the accuracy of each component.

### Establishing a Level of Quantifiable Uncertainty

Determining savings may comprise estimating a difference in level rather than measuring the level of consumption directly. In general, calculating a difference with a given relative precision requires greater absolute precision than for measuring a level of consumption. Therefore, a larger sample would be needed than for measuring a level with the same relative precision. For example, suppose an average load is around 500 kW, and the anticipated savings is around 100 kW. A 10% error with 90% confidence (90/10) criterion applied to the load would require absolute precision of 50 kW at 90 percent confidence. The 90/10 criterion applied to the savings would require absolute precision of 10 kW, at the same confidence level.

Precision criterion may be applied not only to demand or energy savings but also to parameters that determine savings. For example, a savings amount could comprise the product of number (N) of units, hours (H) of operation, and change (C) in watts:

$$Savings Amount = N * H * C \qquad ( Eq . 10 l )$$

Where:

N=Number of units

H=Number of hours of operation

C=Change in watts

The 90/10 criterion could be applied separately to each of these parameters. Achieving 90/10 precision for each of these parameters separately does not imply that 90/10 is achieved for the savings. On the other hand, if number of units and change in watts are assumed to be known without error, 90/10 precision for hours implies 90/10 precision for savings.

The precision standard may be imposed at various levels in an M&V protocol of the present invention. The choice of level of disaggregation may affect the desired sample size and associated monitoring costs. Possible level choices include any one or more of the following:

For individual sites, where sampling is conducted within each site;

For all savings associated with a particular type of technology, across several sites for a given project, where both sites and units within sites may be sampled;

For all savings associated with a particular type of technology in a particular type of usage, across several sites for a project; and

For all savings associated with all technologies and sites for a given energy savings opportunity.

In general, the higher the precision, the higher the data collection requirements. If the primary goal is to ensure savings accuracy for a project or group of projects as a whole, the same precision requirement may not be imposed on each subset. A uniform relative precision target for each subset may conflict with the goal of obtaining the best precision possible for the project as a whole.

### Use of Normalization Factors

Normalization may be further used in measuring and calculating energy savings to compensate for dependence on environmental variables such as occupant behavior, weather, and other factors. This may be conducted only when dependence on these factors is strong.

### Weather Index

Energy consumption is sometimes dependent on the exterior environment. Due to this dependence, it may be preferable to take into account the weather when trying to calculate the energy efficiency of a system. This process is called normalization. Weather normalization may be used for those programs that have weather sensitive energy consumption (such as, for example, HVAC systems, fuel switching, and whole home upgrades). The first step in normalization is to quantify the weather. For example, predicted energy savings from HVAC may be based on the number of annual heating degree days (HDD) or cooling degree days (CDD). By comparing the relationship between energy consumption and HDD, it may be possible to establish what the energy consumption of an upgraded building would be in the same weather that was used to calculate the baseline energy consumption.

The effects of weather may also be considered in analyzing historic energy consumption patterns. For example, a home may have higher energy consumption after an energy efficiency upgrade if the weather is more severe, yet energy consumption would have been even higher had there been no upgrade.

Weather normalization may comprise modeling energy consumption of a home under a number of different weather scenarios. This modeling may be accomplished using software supplied by the U.S. Department of Energy or other appropriate building energy modeling software. Engineering estimates also may be used to estimate energy consumption but this method typically has lower accuracy.

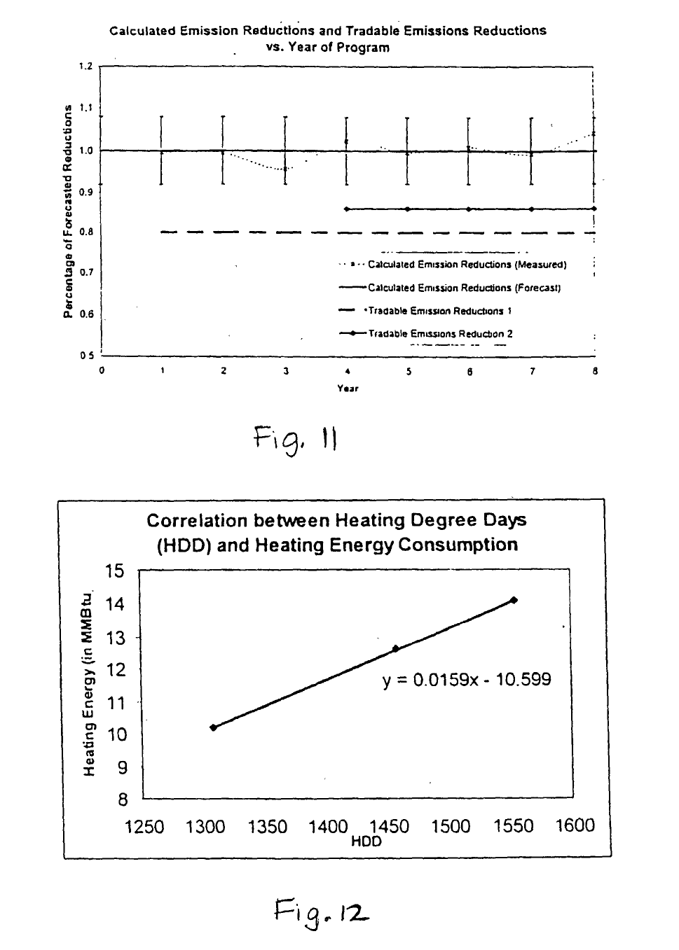

Based on the modeling or engineering estimates, a correlation between Heating Degree Days (HDD) and Cooling Degree Days (CDD) and energy consumption may be developed. For example, FIG. 12 shows the results of modeling the same home under different total number of HDD assumptions.

After a relationship is developed, future weather may be calculated in terms of annual heating degree days. This prediction could be the thirty-year mean temperature, or alternatively, another estimation based on recent historical weather trends. Correlation calculations and assumptions about future weather patterns may be explicitly defined. For example, the graph depicted in FIG. 12 shows heating energy consumption (in MMBtu) equal to 0.0159 (HDD)-10.6.

By including weather normalization in energy consumption calculations, future energy consumption may be calculated and historic energy savings may be analyzed more accurately, than had the effects of weather been ignored.

For the geographic area of a given energy efficiency program, it may be preferable to calculate the historical average and standard deviation of heating degree days (HDD)/cooling degree days (CDD) for various time horizons. These calculations may provide an understanding of the uncertainty induced by weather. For example, the following criteria may be used:

5 year average HDD

5 year standard deviation HDD

5 year average CDD

5 year standard deviation CDD

10 year average HDD

10 year standard deviation HDD

10 year average CDD

10 year standard deviation CDD.

### Occupant Behavior Index

The number and behavior of occupants in a home can substantially affect the energy consumption of a home. Energy conscious people may turn off lights when they leave the room, whereas other inhabitants may not. A two person family may use much less energy than a six person family, all other factors being equal. As a result, energy consumption may shift if the occupants of a home change, regardless of the upgrades undertaken. To compensate for this effect, characteristics of inhabitants may be gathered and used to normalize the model where possible. This additional analysis may be employed when the sample size is small. If there are thousands of homes participating in a given program, the change of inhabitants in one house will likely be balanced by changes elsewhere in the program.

Indices for occupant behavior may be developed by modeling a prototypical house under a number of occupant scenarios. For example, a single home's energy consumption may be determined for a couple, a family of three, and a family of seven. This analysis may be used to develop a relationship (such as a formula) between occupants and energy consumption. Consequently, this relationship may be used to compensate for occupant changes by normalizing raw consumption data for a given household or sets of households.

For example, domestic hot water consumption is highly correlated to the number of inhabitants and therefore a formula may be developed to normalize the hot water consumption for the number of inhabitants.

In addition, household energy consumption is often sensitive to energy prices. As a result, calculations on energy consumption may account for significant price shifts. A formula expressing the relationship between consumer behavior and energy price may be developed for normalization of energy consumption data based on the changes in occupant behavior due to shifts in prices.

It will be apparent to those skilled in the art that various modifications and variations can be made in the construction, configuration, steps, and/or operation of the present invention without departing from the scope or spirit of the invention.

The present invention contemplates participation in existing new source review, open market, and area source emissions trading markets where other pollutants such as NOₓ, VOCs, SO_{X}, PM, and CO and CO₂ emission reductions are traded. Further, a four pollutants—NO₂, SOₓ, CO₂ and mercury—approach to emissions regulation is currently under consideration in legislative arenas. It is expressly contemplated that these—and other pollutants yet to be determined—are within the scope of the present invention.

Furthermore, the method steps of various embodiments of the present invention may be disclosed in participant guidelines, which directives are followed by all program participants in an ETI. The method steps may further be implemented via data processing means. In particular, a system for quantifying residential emissions reductions may comprise client device(s) for inputting energy savings data and other data relating to residential energy savings opportunities. Client device(s) may comprise, but are not limited to, one or more computers or any other suitable hardware device. Client device(s) may communicate with one or more servers via a network, such as, but not limited to, the Internet. One or more databases may reside on server(s) for storing inputted energy savings data and other relevant data. Data stored on database(s) may be processed in accordance with the various calculations disclosed herein for quantifying and aggregating emissions reductions. Software contained on database(s) may comprise program instructions for carrying out the various calculations.

Thus, it is intended that the present invention cover the modifications and variations of the invention, provided they come within the scope of the appended claims and their equivalents.

### Appendix A—Measurement Techniques

### Electricity

A number of different means for measuring energy savings may be employed by the present invention. A method of sensing alternating electrical current (AC) for energy efficiency and savings applications may comprise sensing current with a current transformer or current transducer (CT). CTs may be placed on wires connected to specific loads, such as motors, pumps, or lights, and may be connected to an ammeter, power meter, or other suitable meter device. CTs may have split core or solid torroid configuration. Torroids are typically more economical than split-core CTs, but require a load to be disconnected for a short period while they are installed. Split-core CTs allow installation without disconnecting the load. Both types of CTs may have accuracies better than one percent.

Voltage may be sensed by a direct connection to the power source. In an embodiment of the present invention, voltmeters and power measuring equipment are directly connected to voltage leads. Alternatively, voltmeters and power measuring equipment may utilize an intermediate device, such as a potential transducer (PT), to lower the voltage to safer levels at the meter.

In an embodiment of the present invention, true RMS power digital sampling meters are used for inductive loads such as motors or magnetic ballasts. Though electrical load is the product of voltage and current, separate voltage and current measurements are not preferred for these loads. Such meters are particularly important if variable frequency drives or other harmonic-producing devices are on the same circuit, resulting in the likelihood of harmonic voltages at the motor terminals. True RMS power and energy metering technology, based on digital sampling principles, may be preferred, because of its ability accurately to measure distorted waveforms and properly to record load shapes.

Power measurement equipment meeting the IEEE Standard 519-1992 sampling rate of 3 kHz may be used where harmonic issues are present. Most metering equipment of the type known in the art comprises sampling strategies to address this issue. It may be preferable to obtain documentation from meter manufacturers in order to ascertain that the equipment is accurately measuring electricity use under waveform distortion.

Power may also be measured directly using watt transducers. Watt-hour energy transducers that integrate power over time eliminate the error inherent in assuming or ignoring variations in load over time. Watt-hour transducer pulses may be recorded by a pulse-counting data logger for storage and subsequent retrieval and analysis. An alternative technology comprises combining metering and data logging functions into a single piece of hardware.

In an embodiment of the present invention, hand-held wattmeters, rather than ammeters, are used for spot measurements of watts, volts, amps, power factor, or waveforms. Regardless of the type of solid-state electrical metering device used, the device should meet the minimum performance requirements for accuracy of the American National Standards Institute standard for solid state electricity meters, ANSI C12. 16-1991, published by the Institute of Electrical and Electronics Engineers (IEEE). This standard applies to solid-state electricity meters that are primarily used as watt-hour meters, typically requiring accuracies of one to two percent based on variations of load, power factor, and voltage.

### Runtime

Some equipment may not be continuously metered with recording watt-hour meters to establish energy consumption, such as, for example, constant load motors and lights. For such equipment, determination of energy savings may comprise measuring the time that a piece of equipment is on, and then multiplying it by a short term power measurement. Self-contained battery-powered monitoring devices may be utilized to record equipment runtime and, in some cases, time-of-use information, providing a reasonably priced, simple to install, approach for energy savings calculations.

### Temperature

Computerized temperature measurement devices may comprise resistance temperature detectors (RTDs), thermocouples, thermistors, integrated circuit (IC) temperature sensors, and any other suitable devices for measuring temperature.

Resistance Temperature Detectors (RTDs) are known means in the energy management field for measuring air and water temperature. An RTD measures the change in electrical resistance in materials. RTDs are generally considered accurate, reproducible, stable, and sensitive.

RTDs are economical and readily available in various configurations to measure indoor and outdoor air temperatures, as well as fluid temperatures in chilled water or heating systems. RTDs may comprise 100 and 1,000 Ohm platinum devices in various packaging configurations, further comprising ceramic chips, flexible strips, and thermowell installations.

Depending on the application, two, three, and four-wire RTDs may be employed. Accuracy, distance, and routing between the RTD and the data logging device may determine the specific type of RTD for a project. Four-wire RTDs may offer a high level of precision. Three-wire RTDs may compensate for applications where an RTD requires a long wire lead, exposed to varying ambient conditions. Wires of identical length and material exhibit similar resistance-temperature characteristics and can be used to cancel the effect of the long leads in an appropriately designed bridge circuit. Two-wire RTDs may be field-calibrated to compensate for lead length and may not have lead wires exposed to conditions that vary significantly from those being measured.

For Installation of RTDs, conventional copper lead wire may be used as opposed to the more expensive thermocouple wire. Metering equipment may allow for direct connection of RTDs by providing internal signal conditioning and the ability to establish offsets and calibration coefficients.

Thermocouples measure temperature using two dissimilar metals, joined together at one end, which produce a small unique voltage at a given temperature. The voltage may be measured and interpreted by a thermocouple thermometer. Thermocouples may comprise different combinations of metals, for different temperature ranges. In addition to temperature range, chemical abrasion, vibration resistance, and installation requirements may be considered when selecting a thermocouple.

Thermocouples may be employed when reasonably accurate temperature data are required, such as for thermal energy metering. The main disadvantage of thermocouples is their weak output signal. As a result, thermocouples are sensitive to electrical noise and may require amplifiers. Few energy savings determinations warrant the accuracy and complexity of current thermocouple technology, although improvements in thermocouple technology may make it attractive for a wider variety of applications.

Thermistors are semiconductor temperature sensors comprising an oxide of manganese, nickel, cobalt, or one of several other suitable materials. One difference between thermistors and RTDs is that thermistors exhibit a relatively large resistance change with temperature. Thermistors are not interchangeable, and their temperature-resistance relationship is non-linear. Thermistors may include shielded power lines, filters, or DC voltage, as they are relatively fragile. Thermistors are infrequently used in savings determinations.

Integrated Circuit Temperature Sensors may comprise semiconductor diodes and transistors that exhibit reproducible temperature sensitivities. IC sensors may further comprise an external power source. These devices are occasionally found in HVAC applications where low cost and a strong linear output are required. IC sensors have a fairly good absolute error, but they are fragile and are subject to errors due to self-heating.

### Humidity

Accurate, affordable, and reliable humidity measurement has always been difficult and time-consuming. Equipment to measure relative humidity is commercially available and installation is relatively straightforward. Calibration of humidity sensors may be a concern and may be documented in reporting in conjunction with M&V protocols of the present invention.

### Flow

Flow may be measured for natural gas, oil, steam, condensate, water, and compressed air, among others. Liquid flow measurement devices are well-known prior to the present invention. Flow sensors may be grouped into two general types: intrusive flow meters (using differential pressure and obstruction sensors), and non-intrusive flow meters (using ultrasonic and magnetic sensors).

The appropriate flow meter for a particular application may depend on the type of fluid being measured; how dirty or clean it is; the highest and lowest expected flow velocities; and the budget.

Differential Pressure Flow Meters calculate fluid flow rate by measuring pressure loss across a restriction. This technique is commonly used in building and industrial applications. Pressure drops generated by various shaped restrictions have been well-characterized over the years, and would be known by those of ordinary skill in the art. These “head” flow elements come in a wide variety of configurations, each with strengths and weaknesses. Examples of flow meters utilizing the concept of differential pressure flow measurement include Orifice Plate meter, Venturimeter, and Pitot Tube meter. The accuracy of differential pressure flow meters that may be employed in the present invention is typically from about one to about five percent of the maximum flow for which each meter is calibrated.

Obstruction Flow Meters may provide a linear output signal over a wide range of flow rates, often without the pressure loss penalty incurred with an orifice plate or venturi meter. These meters may comprise a small target, weight, or spinning wheel placed in the flow stream. Fluid velocity may be determined by the rotational speed of the meter (turbine) or by the force on the meter body (vortex).

Turbine meters may measure fluid flow by counting the rotations of a rotor that is placed in a flow stream, providing an output that is linear with flow rate. Turbine meters may comprise an axial-type or insertion-type. Axial turbine meters may have an axial rotor and a housing that is sized for an appropriate installation. Insertion turbine meters may allow the axial turbine to be inserted into the fluid stream and use existing pipe as the meter body. Insertion turbine meters may measure fluid velocity at a single point in the cross-sectional area of the pipe. Total volumetric flow rate for the pipe may be inferred from the measurement. Insertion turbine meters may be installed in straight sections of pipe away from internal flow turbulence.

Vortex meters utilize oscillating instabilities in a low pressure field after it splits into two flow streams around a blunt object to measure flow. Vortex meters require minimal maintenance and have high accuracy and long-term repeatability. Vortex meters may provide a linear output signal that is captured by meter/monitoring equipment.

Non-Interfering Flow Meters may be employed in applications where the pressure drop of an intrusive flow meter is of critical concern, or where the fluid is dirty, such as in sewage, slurries, crude oils, chemicals, some acids, process water, and other similar fluids.

Ultrasonic flow meters may be employed to measure clean fluid velocities by detecting small differences in the transit time of sound waves that are shot at an angle across a fluid stream. Ultrasonic flow meters facilitate rapid measurement of fluid velocities in pipes of varying sizes. Accuracies may range from one percent of actual flow to two percent of full scale. In alternative embodiments, an ultrasound meter that uses the Doppler principle in place of transit time may be employed. In such meters, a certain amount of particles and air are necessary in order for the signal to bounce off and be detected by a receiver. Doppler-effect meters are available with an accuracy between about two percent and about five percent of full scale and cost somewhat less than standard transit time-effect ultrasonic devices. Meter cost is independent of pipe size.

Magnetic flow meters may measure the disturbance that a moving liquid causes in a strong magnetic field. Magnetic flow meters are usually more expensive than other types of meters. Such meters have no moving parts, and are accurate to about one to about two percent range of actual flow.

### Pressure

Mechanical methods of measuring pressure are well-known. U-tube manometers were among the first pressure indicators. Manometers are large, cumbersome, and not well suited for integration into automatic control loops. Manometers are usually found in the laboratory or used as local indicators. Depending on the reference pressure used, they may indicate absolute, gauge, or differential pressure. Pressure measurement devices may be selected based on their accuracy, pressure range, temperature effects, outputs (millivolt, voltage, or current signal), and application environment.

Modern pressure transmitters have been developed from the differential pressure transducers used in flow meters. They may be used in building energy management systems, which are computers programmed to control and/or monitor the operations of energy consuming equipment in a facility, and measure pressure with the necessary accuracy for proper building pressurization and air flow control.

### Thermal Energy

The measurement of thermal energy flow may comprise flow and temperature difference. For example, cooling provided by a chiller is recorded in Btus and is calculated by measuring chilled water flow and the temperature difference between the chilled water supply and return lines. An energy flow meter may perform an internal Btu calculation in real time based on input from a flow meter and temperature sensors. Electronic energy flow meters typically are accurate to better than one percent. They may also provide other useful data on flow rate and temperature (both supply and return).

When a heating or cooling plant is under light load relative to its capacity, there may be as little as a 5° F. difference between the two flowing streams. To avoid significant error in thermal energy measurements, the two temperature sensors may be matched or calibrated. The sensors may be matched or calibrated with respect to one another, rather than to a standard. Suppliers of RTDs provide sets of matched devices.

Typical purchasing specifications may be for a matched set of RTD assemblies (each consisting of an RTD probe, holder, connection head with terminal strip, and a stainless steel thermowell), calibrated to indicate the same temperature, for example within a tolerance of 0.1° F. over the range of 25° F. to 75° F. A calibration data sheet typically is provided with each set. Design and installation of temperature sensors used for thermal energy measurements may consider the error caused by: sensor placement in the pipe; conduction of the thermowell; and any transmitter, power supply, or analog-to-digital converter. Complete error analysis through the measurement system may be preferred.

Thermal energy measurements for steam may require steam flow measurements (e.g., steam flow or condensate flow), steam pressure, temperature, and feedwater temperature where the energy content of the steam is then calculated using steam tables. In instances where steam production is constant, measurements may be reduced to measurement of steam flow or condensate flow (i.e., assumes a constant steam temperature-pressure and feedwater temperature-pressure) along with either temperature or pressure of steam or condensate flow.

Relevant standards and codes for measurement include older, current, more recent, or replacement versions of:

Standard Method for Temperature Measurement (ASHRAE, ANSI/ASHRAE 41.1986 (RA 91));

Standard Method for Pressure Measurement (ASHRAE, ANSI/ASHRAE 41.3-1989 (RA 91)); and

Measurement Uncertainty (American Society for Mechanical Engineers (ASME), ANSI/ASME PTC 19.1-1 985 (R 1990));

each of which is incorporated herein by reference.

### Appendix B—Glossary

The following abbreviations and definitions are used herein:

ACCA—Air Conditioning Contractors of America.

AGA—American Gas Association.

ANSI—American National Standards Institute.

ASHRAE—American Society of Heating, Refrigerating, and Air-Conditioning Engineers.

ASME—American Society for Mechanical Engineers.

Baseline Adjustments—Non-routine adjustments arising during a post-retrofit period that cannot be anticipated and which require custom engineering analysis.

Baseline year Conditions—Set of conditions which gave rise to the energy use/demand of the baseline year.

Baseline year Energy Data—The energy consumption or demand during the base year.

Baseline year—A defined period of any length before implementation of an energy conservation measure (ECM).

CABO—Council of American Building Officials.

CSA—Canadian Standards Association.

CV (RMSE)—Coefficient of Variation of the RMSE.

Degree Day—A measure of heating or cooling load on a facility created by outdoor temperature. When the mean daily outdoor temperature is one degree below a stated reference temperature such as 1° C., for one day, it is defined that there is one heating degree day. If this temperature difference prevailed for ten days there would be ten heating degree days counted for the total period. If the temperature difference were to be 12° for 10 days, 120 heating degree days would be counted. When ambient temperature is below the reference temperature, heating degree days are counted; when ambient temperatures are above the reference, cooling degree days are counted. Any reference temperature may be used for recording degree days, usually chosen to reflect the temperature at which heating or cooling is no longer needed.

Deemed savings—The energy consumption calculated by using a device's power output and length of use. Deemed savings are used when a device is used for predictable time periods and energy consumption does not vary. For example, deemed savings could be used with lights that are on 24 hours a day, 365 days a year (the energy consumption can be calculated with reasonable certainty due to the consistent demand and length of use).

Energy Conservation/Efficiency Measure (ECM or EEM)—A set of activities designed to increase the energy efficiency of a facility. Several ECMs may be carried out in a facility at one time, each for a different purpose. An ECM may involve one or more of: physical changes to facility equipment; revisions to operating and maintenance procedures; software changes; or new means of training or managing users of the space or operations and maintenance staff.

EMS or Energy Management System—A computer that can be programmed to control and/or monitor the operations of energy consuming equipment in a facility.

Energy Performance Contract—A contract between two or more parties where payment is based on achieving specified results, typically, guaranteed reductions in energy consumption and/or operating costs.

Energy Savings—Actual reduction in electricity use (kWh), electric demand (kW), or thermal units (Btu).

M&V or Measurement & Verification—Process of determining savings using a quantifying methodology.

Metering—Collection of energy and water consumption data over time at a facility through the use of measurement devices.

Monitoring—Collection of data at a facility over time for the purpose of savings analysis (i.e., energy and water consumption, temperature, humidity, hours of operation, etc.).

Occupant Behavior Index (OBI)—Indicator variable for the occupant behavior (should range from 0 to 1). This index is used to normalize the energy consumption based on variations in the occupants' behavior or presence. For example, more occupants will place greater demand on HVAC systems. This is used where occupant behavior directly impacts energy consumption.

Post-Retrofit Period—Any period of time following completion of an energy efficient program.

Regression Model—Inverse mathematical model that describes the correlation of independent and dependent variables.

Reserve Coefficient—Ratio of the amount of emission credits held in reserve to the total calculated emission reductions. This factor is used to compensate for the uncertainties in calculating and monitoring energy reductions and emission factors.

RMSE—Root mean square error.

Simulation Model—Assembly of algorithms that calculates energy use based on engineering equations and user-defined parameters.

SMACNA—Sheet Metal and Air Conditioning Contractors' National Association.

UL—Underwriters' Laboratories.

Verification—Process of examining the report of others to comment on its suitability for the intended purpose.

Weather Index—Energy consumption can be heavily dependent on the exterior environment. For example, less heating energy is used during mild winters than in severe winters. Due to this dependence, it is often important to take into account the weather when trying to calculate the energy efficiency of a system. This process is called normalization. The first step in normalization is to quantify the weather. Indicator variables such as heating degree days (HDD) and cooling degree days (CDD) are frequently used for this purpose. By comparing the relationship between energy consumption and HDD, it is possible to establish what the energy consumption of the upgraded building would be in the same weather that was used to calculate the baseline energy consumption.

What is claimed is:

1. A method for quantifying residential emissions reductions, comprising the steps of:
measuring an energy savings resulting from one or more energy savings opportunities in one or more residential properties;
calculating an emissions reduction resulting from the energy savings; and
aggregating a plurality of the emissions reductions into a tradable commodity.

2. The method according to claim 1, wherein the step of calculating an emissions reduction further comprises calculating a reduction in emissions of one or more compounds.

3. The method according to claim 2, wherein the one or more compounds are selected from the group consisting of: SO₂, NOₓ, and GHGs.

4. The method according to claim 1, further comprising the step of monitoring the residential energy savings opportunities.

5. The method according to claim 1, further comprising the step of monitoring the quantification of the emissions reduction.

6. The method according to claim 1, further comprising the step of verifying the quantification of the emissions reduction.

7. A method for quantifying residential emissions reductions, comprising the steps of:
estimating an energy savings resulting from one or more energy savings opportunities in one or more residential properties;
calculating an emissions reduction resulting from the energy savings;
aggregating a plurality of the emissions reductions into a tradable commodity;
monitoring the residential energy savings opportunity;
monitoring the quantification of the emissions reduction; and
verifying the quantification of the emissions reduction.

8. The method according to claim 7, wherein the step of estimating an energy savings further comprises the step of estimating energy saved by one or more energy efficiency upgrades selected from the group consisting of: replacement of an appliance; upgrade of a domestic water heating system; upgrade of a heating system; upgrade of an air conditioning system; modification to lighting; fuel switching; and whole home renovation.

9. The method according to claim 8, wherein the step of aggregating a plurality of the emissions reductions further comprises the step of aggregating the emissions reductions produced by the one or more energy efficiency upgrades into a tradable commodity.

10. The method according to claim 7, wherein the step of aggregating the emissions reductions further comprises the step of pooling the emissions reductions.

11. The method according to claim 7, wherein the step of aggregating the emissions reductions further comprises the step of converting the emissions reductions into one or more emissions trading credits.

12. The method according to claim 7, wherein the step of calculating an emissions reduction further comprises calculating a reduction in emissions of one or more compounds.

13. The method according to claim 12, wherein the one or more compounds are selected from the group consisting of: SO₂, NOₓ, and GHGs.

14. The method according to claim 7, wherein the step of calculating an emissions reduction resulting from the energy savings further comprises the step of calculating a forecasted emissions reduction.

15. The method according to claim 14, wherein the step of calculating a forecasted emissions reduction further comprises the steps of:
estimating a forecasted baseline energy use for the energy savings opportunity;
estimating a forecasted baseline emissions factor for the energy savings opportunity;
calculating a forecasted baseline emissions by multiplying the forecasted baseline energy use with the forecasted baseline emissions factor;
estimating a forecasted program energy use for the energy savings opportunity;
estimating a forecasted program emissions factor for the energy savings opportunity;
calculating a forecasted program emissions by multiplying the forecasted program energy use with the forecasted program emissions factor; and
calculating a forecasted emissions reduction by subtracting the forecasted program emissions from the forecasted baseline emissions.

16. The method according to claim 14, further comprising the step of calculating a tradable portion of the forecasted emissions reduction.

17. The method according to claim 16, wherein the step of calculating a tradable portion of the forecasted emissions reduction further comprises the step of quantifying a technical confidence factor for the energy savings opportunity.

18. The method according to claim 17, wherein the step of quantifying a technical confidence factor further comprises the steps of:
identifying a risk factor for energy savings estimates;
identifying a risk factor for emissions factor estimates;
identifying an adjustment factor; and
determining the technical confidence factor by its relationship to the sum of the risk factor for energy savings estimates, the risk factor for emissions factor estimates, and the adjustment factor.

19. The method according to claim 17, further comprising the steps of:
multiplying the technical confidence factor with the emissions reduction to obtain the tradable portion of the emissions reduction, wherein the remaining portion of the emissions reduction is non-tradable; and
holding the non-tradable portion in reserve for possible conversion into a tradable commodity.

20. The method according to claim 19, further comprising the step of converting any portion of the non-tradable portion into a tradable commodity.

21. The method according to claim 14, wherein the step of calculating a forecasted emissions reduction further comprises the steps of:
calculating a plurality of annual forecasted emissions reductions for the residential energy savings opportunities; and
summing the plurality of annual forecasted emissions reductions to determine a lifetime emissions reduction estimate for the residential savings opportunities.

22. The method according to claim 7, wherein the step of monitoring the residential savings opportunity further comprises the steps of:
compiling data on the energy savings collected at a facility; and
managing the energy savings data.

23. The method according to claim 7, wherein the step of verifying the quantification of the emissions reduction further comprises the steps of:
calculating a measured emissions reduction; and
comparing the measured emissions reduction to a forecasted emissions reduction.

24. The method according to claim 23, wherein the step of calculating a measured emissions reduction further comprises the step of collecting data for the energy savings opportunity.

25. The method according to claim 23, wherein the step of calculating a measured emissions reduction further comprises the steps of:
estimating a measured baseline energy use for the energy savings opportunity;
estimating a measured baseline emissions factor for the energy savings opportunity;
calculating a measured baseline emissions by multiplying the measured baseline energy use with the measured baseline emissions factor;
estimating a measured program energy use for the energy savings opportunity;
estimating a measured program emissions factor for the energy savings opportunity;
calculating a measured program emissions by multiplying the measured program energy use with the measured program emissions factor; and
calculating a measured emissions reduction by subtracting the measured program emissions from the measured baseline emissions.

26. The method according to claim 25, wherein the step of estimating a measured baseline energy use is selected from one or more of the group consisting of conducting: on-site inspection; metering; sub-metering; utility bill analysis; and engineering modeling.

27. The method according to claim 26, wherein the step of conducting engineering modeling further comprises the step of utilizing one or more of: engineering calculations and computer simulation.

28. The method according to claim 26, wherein the step of conducting engineering modeling further comprises the step of conducting one or more of: degree day analysis; bin analysis; hourly analysis; and time-step analysis.

29. The method according to claim 25, wherein the step of estimating a measured program energy use is selected from one or more of the group consisting of conducting: on-site inspection; metering; sub-metering; utility bill analysis; and engineering modeling.

30. The method according to claim 29, wherein the step of conducting engineering modeling further comprises the step of utilizing one or more of: engineering calculations and computer simulation.

31. The method according to claim 29, wherein the step of conducting engineering modeling further comprises conducting one or more of: degree day analysis; bin analysis; hourly analysis; and time-step analysis.

32. A method for quantifying a tradable emissions commodity, comprising the steps of:
offering a plurality of residential energy efficiency programs, wherein the energy efficiency programs comprise a plurality of residential energy savings opportunities;
estimating an energy savings resulting from the plurality of residential energy savings opportunities;
calculating emissions reductions resulting from the energy savings;
aggregating the emissions reductions into a tradable commodity;
monitoring the residential energy savings opportunities;
monitoring the quantification of the emissions reductions;
verifying the quantification of the tradable emissions reductions to produce a tradable commodity.

33. The method according to claim 32, wherein the plurality of residential energy efficiency programs are offered by one or more emissions trading partners.

34. The method according to claim 32, wherein the step of verifying the quantification of the tradable emissions reductions further comprises the step of producing a commodity that is tradable on national and international emissions trading markets.

35. The method according to claim 32, further comprising the step of offering to a market one or more of the tradable commodities.

36. The method according to claim 35, wherein the step of offering to a market one or more of the tradable commodities further comprises the step of managing one or more transactions of the tradable commodities in the market.

37. A system for quantifying residential emissions reductions, comprising:
one or more client devices for inputting data relating to one or more residential energy savings opportunities into the system;
one or more servers, which communicate with the one or more client devices via a network;
one or more databases residing on the one or more servers for storing the inputted data; and
means for processing the inputted data to quantify an emissions reduction for the one or more residential energy savings opportunities and aggregate the emissions reduction into a tradable commodity.
